(19) United States
(12) Patent Application Publication
(10) Pub. No.: US 2014/0295145 A1
(43) Pub. Date: Oct. 2, 2014

(54) LIPOPHILIC LAMINATE, METHOD FOR MANUFACTURING THE SAME, PRODUCT, AND METHOD FOR MANUFACTURING THE SAME

(71) Applicant: DEXERIALS CORPORATION, Tokyo (JP)

(72) Inventors: Mikihisa Mizuno, Tochigi (JP); Ryosuke Iwata, Tochigi (JP); Shinobu Hara, Tochigi (JP)

(73) Assignee: DEXERIALS CORPORATION, Tokyo (JP)

(21) Appl. No.: 14/223,613

(22) Filed: Mar. 24, 2014

(30) Foreign Application Priority Data
Mar. 27, 2013 (JP) 2013-066407

(51) Int. Cl. B32B 3/26; B29C 59/02; B29C 35/08; C09D 5/16; B29C 59/16

(52) U.S. Cl. CPC B32B 3/263; C09D 5/1681; B29C 59/16; B29C 35/08; B29C 59/026; B29C 2035/0283
USPC 428/172; 427/487; 264/250; 264/478

(57) ABSTRACT

A lipophilic laminate, including: a substrate made of a resin; and a lipophilic resin layer on the substrate made of a resin, wherein the lipophilic resin layer includes micro convex portions or micro concave portions in a surface thereof, and wherein an oleic acid contact angle of the surface of the lipophilic resin layer is 10° or less.

This application claims priority to Japanese application No. 2013-066407 filed on Mar. 27, 2013, which is hereby incorporated by reference in its entirety.

### BACKGROUND OF THE INVENTION

1. Field of the Invention

The present invention relates to a lipophilic laminate, a method for manufacturing the lipophilic laminate, a product using the lipophilic laminate and a method for manufacturing the product.

2. Description of the Related Art

When fingerprints are deposited on a surface of an article, the article is aesthetically spoiled. For example, when a fingerprint is deposited on a surface of the piano, high quality furniture, or an automobile interior and exterior part, it is aesthetically spoiled and become unseemly.

Additionally, when fingerprints are deposited on a surface of an article, an optical property thereof (e.g., visibility) is deteriorated. For example, a touch panel of an information display (e.g., a smartphone or a tablet PC) in which the touch panel is used as a user interface has an advantage of capable of being intuitively operated by directly touching a display screen with a finger. However, when fingerprints are deposited on the touch panel, visibility of the screen is deteriorated.

In view of this, for example, there has been proposed, as a surface of the display screen of the touch panel, an antifouling layer of which most superficial surface is formed of a fluorine compound or a silicone compound (see, for example, Japanese Patent (JP-B) No. 4666667). This proposed technology is advantageous in that formation of a water- and oil-repellent surface weakens the adhesive force of an oil component contained in the fingerprints, which allows the fingerprints to be easily wiped-out with, for example, a cloth.

However, unless the fingerprints are wiped-out with, for example, the cloth, the oil component is repelled from a surface of the layer to thereby form a droplet, which disadvantageously scatters light and make the fingerprints conspicuous.

Therefore, there has been a need for a surface of an article on which fingerprints is inconspicuous, i.e., which has fingerprint resistance. For example, there has been proposed a water-repellent and lipophilic surface which does not repel the oil component (see, for example, Japanese Patent Application Laid-Open (JP-A) No. 2010-128363). In this proposed technology, the oil component of the fingerprint deposited on the surface spreads out and does not form a droplet, so that the fingerprint becomes inconspicuous.

However, a pattern of the fingerprint remains. Therefore, unless the fingerprint is wiped-out with a cloth, light scattering due to the pattern of the fingerprint disadvantageously makes the deposited fingerprint visible.

In addition, in these proposed technologies, after repeatedly wiping-out the fingerprint with, for example, the cloth, a material of the most superficial surface of the article is gradually removed, which disadvantageously deteriorates a fingerprint wiping-out property, and a fingerprint resistance (inconspicuousness of fingerprint).

Therefore, in the circumstances, it is presently desired to provide a lipophilic laminate which has an excellent fingerprint resistance even after repeatedly wiped-out, a method for manufacturing the lipophilic laminate, a product using the lipophilic laminate, and a method for manufacturing the product.

### SUMMARY OF THE INVENTION

An object of the present invention is to solve the aforementioned problems in the art and attain the following object. More specifically, an object of the present invention is to provide a lipophilic laminate which has an excellent fingerprint resistance even after repeatedly wiped-out, a method for manufacturing the lipophilic laminate, a product using the lipophilic laminate, and a method for manufacturing the product.

The means for solving the aforementioned problems are as follows.

In one aspect, the present invention provides a lipophilic laminate, including:

a substrate made of a resin; and

a lipophilic resin layer on the substrate made of a resin,

wherein the lipophilic resin layer includes micro convex portions or micro concave portions in a surface thereof, and

wherein an oleic acid contact angle of the surface of the lipophilic resin layer is 10° or less.

In one variant, the present invention provides a lipophilic laminate wherein the lipophilic laminate has an elongation percentage of 10% or more.

In one variant, the present invention provides a lipophilic laminate wherein a Martens hardness of the lipophilic resin layer is 50 N/mm² to 300 N/mm².

In one variant, the present invention provides a lipophilic laminate further including an anchor layer between the substrate made of a resin and the lipophilic resin layer.

In one variant, the present invention provides a lipophilic laminate wherein the oleic acid contact angle of the surface of the lipophilic resin layer gets smaller over time when the oleic acid contact angle is measured.

In one variant, the present invention provides a lipophilic laminate wherein the micro convex portions or the micro concave portions are spaced from each other.

In another aspect, the present invention provides a method for manufacturing the lipophilic laminate of the present invention wherein the method includes:

forming an uncured resin layer by applying an active energy ray curable resin composition to a substrate made of a resin; and

forming a lipophilic resin layer by bringing a transfer matrix having micro convex portions or micro concave portions into contact with the uncured resin layer, irradiating the uncured resin layer in contact with the transfer matrix with an active energy ray to cure the uncured resin layer, thereby transferring the micro convex portions or the micro concave portions.

In one variant, the present invention provides a method for manufacturing the lipophilic laminate wherein the micro convex portions or the micro concave portions of the transfer matrix are formed by etching a surface of the transfer matrix with a photoresist having a predetermined pattern shape used as a protection film.

In one variant, the present invention provides a method for manufacturing the lipophilic laminate wherein the micro convex portions or the micro concave portions of the transfer matrix are formed by laser processing of a surface of the transfer matrix by irradiating the surface of the transfer matrix with a laser beam.

In another aspect, the present invention provides a product, including:

the lipophilic laminate according to any one of 1 to 6 on a surface thereof.

In one variant, the present invention provides a method for manufacturing the product of the present invention, wherein the method includes:

heating a lipophilic laminate;

molding the lipophilic laminate heated into a desired shape; and

injecting a molding material to the lipophilic laminate molded in the desired shape at a side of the substrate made of a resin and molding the molding material.

In one variant, the present invention provides a method for manufacturing the product according to the present invention, wherein the heating is performed by infrared heating.

According to the present invention, the problems in the art are overcome and the objects of the present invention can be attained, and it is possible to provide a lipophilic laminate which has an excellent fingerprint resistance even after repeatedly wiped-out, a method for manufacturing the lipophilic laminate, a product using the lipophilic laminate and a method for manufacturing the product.

### BRIEF DESCRIPTION OF THE DRAWINGS

FIG. 1A is an atomic force microscope (AFM) image showing an example of a surface of a lipophilic resin layer having convex portions;

FIG. 1B is a cross sectional view along the a-a line in FIG. 1A;

FIG. 1C is an AFM image (three-dimensional image) of the lipophilic resin layer in FIG. 1A;

FIG. 1D is a scanning electron microscope (SEM) image of the lipophilic resin layer in FIG. 1A;

FIG. 2A is an AFM image showing an example of a surface of a lipophilic resin layer having concave portions;

FIG. 2B is a cross sectional view along the a-a line in FIG. 2A;

FIG. 3A is a perspective view showing an example of the constitution of a roll matrix that is a transfer matrix;

FIG. 3B is a plane view represented by enlarging a part of the roll matrix shown in FIG. 3A;

FIG. 3C is a cross sectional view along the track T in FIG. 3B;

FIG. 4 is a schematic diagram showing an example of the constitution of an exposure apparatus for a roll matrix for preparing a roll matrix;

FIG. 5A is a process drawing for describing an example of a process for preparing a roll matrix;

FIG. 5B is a process drawing for describing an example of a process for preparing a roll matrix;

FIG. 5C is a process drawing for describing an example of a process for preparing a roll matrix;

FIG. 5D is a process drawing for describing an example of a process for preparing a roll matrix;

FIG. 5E is a process drawing for describing an example of a process for preparing a roll matrix;

FIG. 6A is a process drawing for describing an example of a process for transferring micro convex portions or concave portions by a roll matrix;

FIG. 6B is a process drawing for describing an example of a process for transferring micro convex portions or concave portions by a roll matrix;

FIG. 6C is a process drawing for describing an example of a process for transferring micro convex portions or concave portions by a roll matrix;

FIG. 7A is a plane view showing an example of the constitution of a sheet-like matrix that is a transfer matrix;

FIG. 7B is a cross sectional view along the a-a line shown in FIG. 7A;

FIG. 7C is a cross sectional view represented by enlarging a part of FIG. 7B;

FIG. 8 is a schematic diagram for showing an example of the constitution of a laser processing apparatus for preparing a sheet-like matrix;

FIG. 9A is a process drawing for describing an example of a process for preparing a sheet-like matrix;

FIG. 9B is a process drawing for describing an example of a process for preparing a sheet-like matrix;

FIG. 9C is a process drawing for describing an example of a process for preparing a sheet-like matrix;

FIG. 10A is a process drawing for describing an example of a process for transferring micro convex portions or concave portions by a sheet-like matrix;

FIG. 10B is a process drawing for describing an example of a process for transferring micro convex portions or concave portions by a sheet-like matrix;

FIG. 10C is a process drawing for describing an example of a process for transferring micro convex portions or concave portions by a sheet-like matrix;

FIG. 11 is a schematic cross sectional view of an example of a lipophilic laminate manufactured according to the fourth embodiment.

FIG. 12A is a process drawing for describing an example of manufacturing a product of the present invention by in-mold molding;

FIG. 12B is a process drawing for describing an example of manufacturing a product of the present invention by in-mold molding;

FIG. 12C is a process drawing for describing an example of manufacturing a product of the present invention by in-mold molding;

FIG. 12D is a process drawing for describing an example of manufacturing a product of the present invention by in-mold molding;

FIG. 12E is a process drawing for describing an example of manufacturing a product of the present invention by in-mold molding;

FIG. 12F is a process drawing for describing an example of manufacturing a product of the present invention by in-mold molding;

FIG. 13A is an AFM image of a surface of the lipophilic resin layer of the lipophilic laminate of Example 1;

FIG. 13B is a cross sectional view along the a-a line in FIG. 13A;

FIG. 13C is an AFM image (three-dimensional image) of the lipophilic resin layer in FIG. 13A;

FIG. 13D is a scanning electron microscope (SEM) image of the lipophilic resin layer in FIG. 13A;

FIG. 14A is an AFM image of a surface of the lipophilic resin layer of the lipophilic laminate of Example 2;

FIG. 14B is a cross sectional view along the a-a line in FIG. 14A;

FIG. 14C is an AFM image (three-dimensional image) of the lipophilic resin layer in FIG. 14A;

FIG. 14D is a scanning electron microscope (SEM) image of the lipophilic resin layer in FIG. 14A;

FIG. 15A is an AFM image of a surface of the lipophilic resin layer of the lipophilic laminate of Example 3;

FIG. 15B is a cross sectional view along the a-a line in FIG. 15A;

FIG. 15C is an AFM image (three-dimensional image) of the lipophilic resin layer in FIG. 15A;

FIG. 15D is a scanning electron microscope (SEM) image of the lipophilic resin layer in FIG. 15A;

FIG. 16A is an AFM image of a surface of the lipophilic resin layer of the lipophilic laminate of Example 4;

FIG. 16B is a cross sectional view along the a-a line in FIG. 16A;

FIG. 16C is an AFM image (three-dimensional image) of the lipophilic resin layer in FIG. 16A;

FIG. 16D is a scanning electron microscope (SEM) image of the lipophilic resin layer in FIG. 16A;

FIG. 17A is an AFM image of a surface of the lipophilic resin layer of the lipophilic laminate of Example 7;

FIG. 17B is a cross sectional view along the a-a line in FIG. 17A;

FIG. 17C is an AFM image (three-dimensional image) of the lipophilic resin layer in FIG. 17A;

FIG. 18A is an AFM image of a surface of the lipophilic resin layer of the lipophilic laminate of Example 8;

FIG. 18B is a cross sectional view along the a-a line in FIG. 18A;

FIG. 18C is an AFM image (three-dimensional image) of the lipophilic resin layer in FIG. 18A;

FIG. 19A is an AFM image of a surface of the lipophilic resin layer of the lipophilic laminate of Example 9;

FIG. 19B is a cross sectional view along the a-a line in FIG. 19A;

FIG. 19C is an AFM image (three-dimensional image) of the lipophilic resin layer in FIG. 19A;

FIG. 20A is an AFM image of a surface of the lipophilic resin layer of the lipophilic laminate of Example 10;

FIG. 20B is a cross sectional view along the a-a line in FIG. 20A;

FIG. 20C is an AFM image (three-dimensional image) of the lipophilic resin layer in FIG. 20A;

FIG. 21 is a graph showing changes of oleic acid contact angles of laminates obtained in Examples 1 to 4, 7, and 8, and Comparative Examples 1 and 3; and

FIG. 22 is a graph showing changes of oleic acid contact angles of laminates obtained in Examples 11 to 15, and Comparative Examples 4 and 5.

### DETAILED DESCRIPTION OF THE INVENTION

### Lipophilic Laminate

The lipophilic laminate of the present invention contains at least: a substrate made of a resin, and a lipophilic resin layer; and further contains other members as necessary.

### Substrate Made of a Resin

The material for the substrate made of a resin is not particularly limited and can be appropriately selected depending upon the purpose. Examples of the material include triacetylcellulose (TAC), polyester (TPEE), polyethylene terephthalate (PET), polyethylenenaphthalate (PEN), polyimide (PI), polyamide (PA), aramid, polyethylene (PE), polyacrylate, polyethersulfone, polysulfone, polypropylene (PP), polystyrene, diacetylcellulose, poly(vinyl chloride), an acrylic resin (PMMA), polycarbonate (PC), an epoxy resin, a urea resin, a urethane resin, a melamine resin, a phenolic resin, an acrylonitrile-butadiene-styrene copolymer, a cycloolefin polymer (COP), a cycloolefin copolymer (COC), a PC/PMMA laminate, and a rubber-added PMMA.

The substrate made of a resin preferably has transparency.

The form of the substrate made of a resin, which is not particularly limited and can be appropriately selected depending upon the purpose, is preferably a film form.

If the substrate made of a resin is a film, the average thickness of the substrate made of a resin, which is not particularly limited and can be appropriately selected depending upon the purpose, is preferably 5 μm to 1,000 μm and more preferably 50 μm to 500 μm.

On the surface of the substrate made of a resin, letters, patterns and images, etc. may be printed.

On the surface of the substrate made of a resin, a binder layer may be provided in order to increase adhesion between the substrate made of a resin and a molding material in forming the lipophilic laminate in a molding process or in order to protect the letters, patterns and images from flow resistive pressure of the molding material during a molding process. As the material for the binder layer, binders made of acryl, urethane, polyester, polyamide, ethylene butyl alcohol, and an ethylene-vinyl acetate copolymer; and adhesives can be used. Note that the binder layer may be formed of two layers or more. As the binder to be used, a binder having heat-sensitivity and pressure-sensitivity suitable for a molding material can be selected.

### Lipophilic Resin Layer

The lipophilic resin layer has micro convex portions or micro concave portions in the surface.

The oleic acid contact angle of the surface of the lipophilic resin layer is 10° or less.

The lipophilic resin layer is formed on the substrate made of a resin.

The lipophilic resin layer, which is not particularly limited and can be appropriately selected depending upon the purpose, preferably contains a cured product of an active energy ray curable resin composition.

### —Micro Convex Portion and Micro Concave Portion—

The lipophilic resin layer contains micro convex portions or micro concave portions in a surface thereof.

The micro convex portions or micro concave portions are formed in the surface of the lipophilic resin layer, which is an opposite surface to the surface facing the substrate made of a resin.

The micro convex portions herein refer to those formed on the surface of the lipophilic resin layer and arranged at an average interval (distance) of 1,000 nm or less.

The micro concave portions herein refer to those formed in the surface of the lipophilic resin layer and arranged at an average interval (distance) of 1,000 nm or less.

The shapes of the convex portions and the concave portions are not particularly limited and can be appropriately selected depending upon the purpose. Examples of the shapes include cone-shaped, columnar, needle, a partially spherical shape (for example, semispherical shape), a partially ellipsoidal shape (for example, semi-ellipsoidal shape) and a polygonal shape. It is not necessary that these shapes are those completely satisfying mathematical definitions and may have distortion to some extent.

The convex portions or the concave portions are two-dimensionally arranged in the surface of the lipophilic resin layer. The convex portions or the concave portions may be regularly or randomly arranged. In the case of regular arrangement, the convex portions or the concave portions are most densely arranged.

The average distance between adjacent convex portions, which is not particularly limited and can be appropriately selected depending upon the purpose, is preferably 5 nm to 1,000 nm, more preferably 10 nm to 800 nm, and particularly preferably 50 nm to 500 nm.

The average distance between adjacent concave portions, which is not particularly limited and can be appropriately selected depending upon the purpose, is preferably 5 nm to 1,000 nm, more preferably 10 nm to 800 nm, and particularly preferably 50 nm to 500 nm.

If each of the average distances between adjacent convex portions and the average distance between adjacent concave portions falls within the preferable range, a fingerprint component deposited onto the lipophilic resin layer effectively spreads in wet condition, and a fingerprint wiping-out property is improved. If each of the average distances falls within the particularly preferable range, a fingerprint component significantly effectively spreads in wet condition, and a fingerprint wiping-out property is significantly improved.

The average height of the convex portions, which is not particularly limited and can be appropriately selected depending upon the purpose, is preferably 1 nm to 1,000 nm, more preferably 5 nm to 500 nm, further preferably 10 nm to 300 nm, and particularly preferably 10 nm to 150 nm.

The average depth of the concave portions, which is not particularly limited and can be appropriately selected depending upon the purpose, is preferably 1 nm to 1,000 nm, more preferably 5 nm to 500 nm, further preferably 10 nm to 300 nm, and particularly preferably 10 nm to 150 nm.

If each of the average height of the convex portions and the average depth of the concave portions falls within the preferable range, a fingerprint component deposited onto the lipophilic resin layer effectively spreads in wet condition, and a fingerprint wiping-out property is improved. If each of the average height and the average depth falls within the particularly preferable range, a fingerprint component significantly effectively spreads in wet condition, and a fingerprint wiping-out property is significantly improved.

The average aspect ratio (the average height of the convex portions/the average distance between adjacent convex portions) of the convex portions and the average aspect ratio (the average depth of the concave portions/the average distance of adjacent concave portions) of the concave portions, which are not particularly limited and can be appropriately selected depending upon the purpose, are each preferably 0.001 to 1,000, more preferably 0.01 to 50, and particularly preferably 0.04 to 3.0.

If each of the average aspect ratio of the convex portions and the average aspect ratio of the concave portions falls within the preferable range, a fingerprint component deposited onto the lipophilic resin layer effectively spreads in wet condition, and a fingerprint wiping-out property is improved. If each of the aspect ratios falls within the particularly preferable range, a fingerprint component significantly effectively spreads in wet condition, and a fingerprint wiping-out property is significantly improved.

The average distance (Pm) of convex portions or concave portions herein and the average height of convex portions or average depth (Hm) of concave portions can be determined as follows.

First, the surface S of the lipophilic resin layer having convex portions or concave portions is observed by an atomic force microscope (AFM). From a section profile by the AFM, the pitch of convex portions or concave portions, and the height of the convex portion or the depth of the concave portion are obtained. This procedure is repeated with respect to 10 sites randomly selected from the surface of the lipophilic resin layer to obtain pitch P1, P2, . . . , P10 and the height or depth H1, H2, . . . , H10.

The pitch of the convex portions herein is the distance between the peaks of convex portions. The pitch of the concave portions is the distance between the deepest points of concave portions. The height of the convex portion is the height of the convex portion based on the lowest point of the valley portion between the convex portions. The depth of the concave portion is the depth of the concave portion based on the highest point of the mount portion between the concave portions.

Then, these pitches P1, P2, . . . , P10, and height or depth H1, H2, . . . , H10 are simply averaged (arithmetic average), respectively to obtain the average distance (Pm) of convex portions or concave portions, average height of convex portions or the average depth (Hm) of the concave portions.

Note that if the pitch of the convex portion or concave portion has in-plane anisotropy, the pitch in the direction giving a maximum value is used to obtain Pm. If the height of the convex portion or the depth of the concave portion has in-plane anisotropy, the height or depth in the direction giving a maximum value is used to obtain Hm.

If the convex portions or concave portions have rod shapes, the pitch in the minor axis direction is used as the pitch.

Note that in the AFM observation, in order for the convex peak or the bottom edge of the concave in a section profile to match the convex peak or the deepest portion of the concave portion of a three dimensional shape, the section profile is cut out in such a way that a cut line passes through the convex peak of the three dimensional shape to be measured or the deepest portion of the concave portion of the three dimensional shape.

Whether the micro structures formed in the surface of the lipophilic resin layer are convex portions or concave portions can be determined as follows.

The surface S of the lipophilic resin layer having convex portions or concave portions is observed by an atomic force microscope (AFM), AFM images of the section and the surface S are obtained.

In the AFM image of the surface, the image in the most superficial side is obtained as a bright image, whereas the image of the deepest side is obtained as a dark image. If a bright image is formed like an island in a dark image, it is determined that the surface has a convex portion.

Conversely, if a dark image is formed like an island in a bright image, it is determined that the surface has a concave portion.

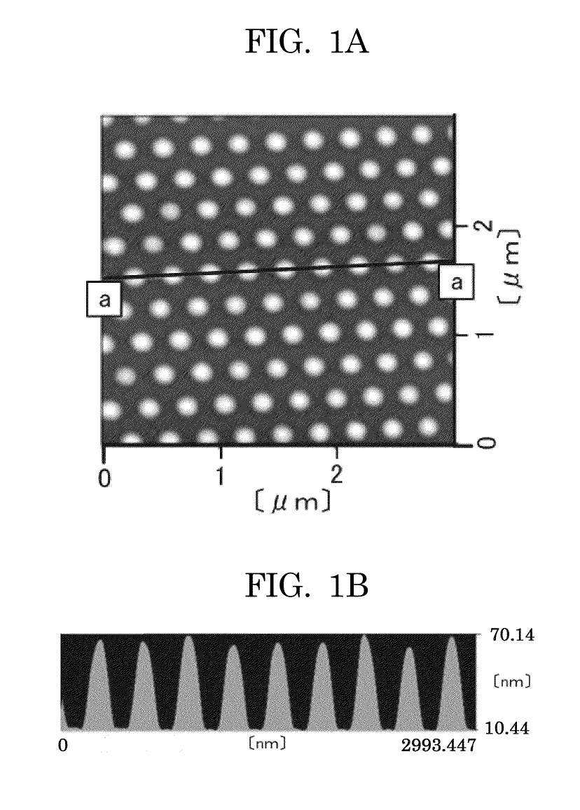

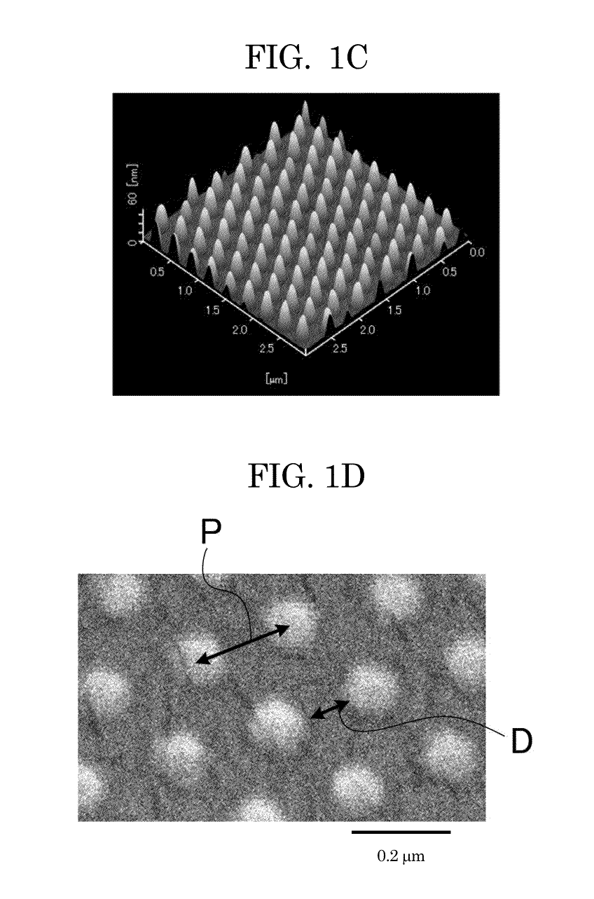

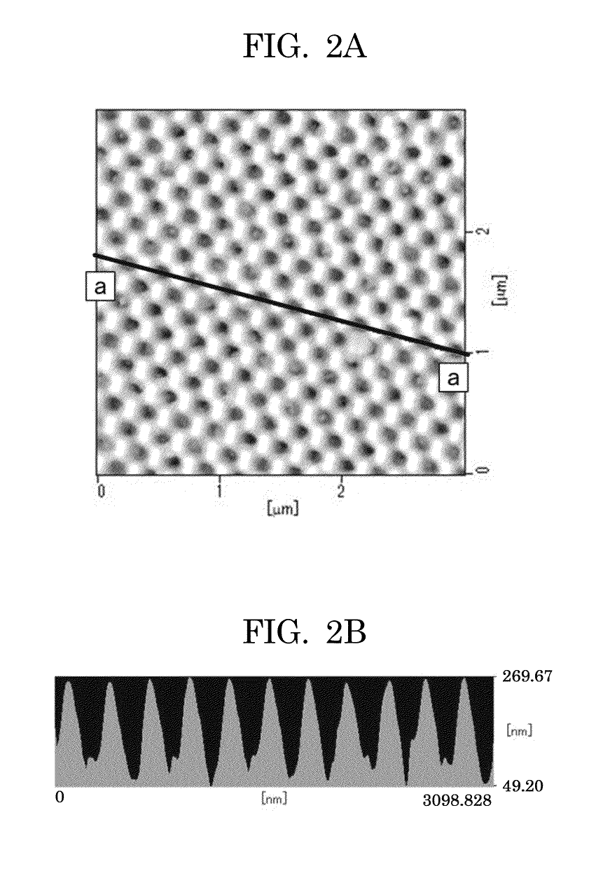

For example, the surface of a lipophilic resin layer providing AFM images of the surface and section shown in FIG. 1A and FIG. 1B, respectively, has convex portions. A three-dimensional image of the lipophilic resin layer providing AFM images of the surface and section shown in FIGS. 1A and 1B, respectively, is shown in FIG. 1C. The surface of a lipophilic resin layer providing AFM images of the surface and section shown in FIG. 2A and FIG. 2B, respectively, has concave portions.

The adjacent convex portions or concave portions are preferably spaced from each other. The average distance of space (the average space distance) between adjacent convex portions or concave portions, which is not particularly limited and can be appropriately selected depending upon the purpose, is preferably 1 nm to 999 nm, more preferably 5 nm to 795 nm, further preferably 10 nm to 490 nm, and particularly preferably 100 nm to 190 nm. If the average space distance falls within the preferable range, a fingerprint component deposited onto the lipophilic resin layer effectively spreads in wet condition, and a fingerprint wiping-out property is improved. If the average space distance falls within the particularly preferable range, a fingerprint component significantly effectively spreads in wet condition, and a fingerprint wiping-out property is significantly improved.

The average space distance (Dm) of convex portions or concave portions, which are spaced from each other, can be determined as follows.

First, the surface S of the lipophilic resin layer is observed by a scanning electron microscope (SEM). From the SEM image of the surface, the space distance between adjacent convex portions or concave portions is obtained. The space distance is a shortest distance between outer edges of adjacent convex portions or concave portions as the surface S is viewed from above. This procedure is repeated with respect to 10 sites randomly selected from the surface of the lipophilic resin layer to obtain the space distance D1, D2, . . . , D10.

Then, these space distances D1, D2, . . . , D10 are simply averaged (arithmetic average), respectively to obtain the average space distance (Dm) of convex portions or concave portions.

For example, a SEM image of the lipophilic resin layer providing AFM images of the surface and section shown in FIGS. 1A and 1B, respectively, is shown in FIG. 1D. In FIG. 1D, the pitch (P) of convex portions is 310 nm, and the space distance (D) of convex portions is 170 nm.

### Oleic Acid Contact Angle

The oleic acid contact angle of the surface of the lipophilic resin layer is 10° or less, preferably 5.0° or less, and more preferably 3.0° or less. The lower limit of the oleic acid contact angle, which is not particularly limited and can be appropriately selected depending upon the purpose, is, for example, 1.0°.

The oleic acid contact angle can be measured use of, for example, PCA-1 (manufactured by Kyowa Interface Science Co., Ltd.) in the following conditions.

Oleic acid is placed in a plastic syringe. To the tip of the syringe, a Teflon-coated needle is attached. The oleic acid is allowed to drip on an evaluation surface.

The amount of oleic acid to be dripped: 1 μL

The measurement temperature: 25° C.

Contact angles 100 seconds after oleic acid is dripped are measured with respect to any 10 sites on the surface of the lipophilic resin layer. These contact angles are averaged to obtain the oleic acid contact angle.

The oleic acid contact angle of the surface of the lipophilic resin layer preferably gets smaller over time, more preferably gets smaller by 1.0° or more during the period from 20 seconds to 100 seconds after oleic acid is dripped, and particularly preferably gets smaller by 2.0° or more during the above-described period, which allows for an excellent wiping-out property of a deposited fingerprint with a finger, a tissue, or a cloth.

### Active Energy Ray Curable Resin Composition

The active energy ray curable resin composition is not particularly limited and can be appropriately selected depending upon the purpose, as long as it can achieve a desired oleic acid contact angle in a lipophilic resin layer formed after curing. For example, an active energy ray curable resin composition containing at least a polyfunctional (meth)acrylic monomer and a photopolymerization initiator, and further containing other components as necessary, is mentioned.

Polyfunctional (meth)acrylic Monomer

Examples of the polyfunctional (meth)acrylic monomer include 1,3-butylene glycol diacrylate, diethylene glycol diacrylate, neopentyl glycol diacrylate, tripropylene glycol diacrylate, ethoxylated (3) bisphenol A diacrylate, dipropylene glycol diacrylate, acrylate ester (dioxane glycol diacrylate), ethoxylated (4) bisphenol A diacrylate, isocyanuric acid EO-modified diacrylate, tricyclodecane dimethanol diacrylate, ethylene glycol dimethacrylate, 1,4-butanediol dimethacrylate, diethylene glycol dimethacrylate, 1,12-dodecanediol dimethacrylate, 1,3-butylene glycol dimethacrylate, ethoxylated (4) bisphenol A dimethacrylate, and ethoxylated (6) bisphenol A dimethacrylate. These may be used alone or in combination.

Additionally, as the polyfunctional (meth)acrylic monomer, difunctional urethane (meth)acrylate, difunctional epoxy(meth)acrylate, and difunctional polyester (meth)acrylate are mentioned

The difunctional urethane (meth)acrylate may be a commercially available product. Examples of the commercially available product include CN940, CN963, CN963A80, CN963B80, CN963E75, CN963E80, CN982A75, CN982B88, CN983, CN985B88, CN9001, CN9011, CN902J75, CN977C70, CN999, CN1963, and CN2920 (all manufactured by Sartomer Company, Inc.); EBECRYL 284 (manufactured by DAICEL-ALLNEX LTD.); and AT-600, and UF-8001G (manufactured by kyoeisha Chemical Co., Ltd.).

The difunctional epoxy(meth)acrylate may be a commercially available product. Examples of the commercially available product include CN104, CN104A80, CN104B80, CN104D80, CN115, CN117, CN120, CN120A75, CN120B60, CN120B80, CN120060, CN120080, CN120D80, CN120E50, CN120M50, CN136, CN151, CN UVE151, CN UVE150/80, CN2100 (all manufactured by Sartomer Company, Inc.); EBECRYL 600, EBECRYL 605, EBECRYL 3700, EBECRYL 3701, EBECRYL 3702, and EBECRYL 3703 (manufactured by DAICEL-ALLNEX LTD.); and 70PA, 200PA, 80MFA, 3002A, and 3000A (manufactured by kyoeisha Chemical Co., Ltd.).

The difunctional polyester (meth)acrylate may be a commercially available product. Examples of the commercially available product include CN2203, and CN2272 (both manufactured by Sartomer Company, Inc.).

The glass transition temperature (Tg) of the polyfunctional (meth)acrylic monomer, which is not particularly limited and can be appropriately selected depending upon the purpose, is preferably 50° C. or more. The Tg can be determined by means of a differential scanning calorimeter or a thermomechanical analysis device using, as a specimen, a cured product produced by incorporating 5 parts by mass of the polymerization initiator into 100 parts by mass of the polyfunctional (meth)acrylic monomer, and irradiating with ultraviolet having the irradiation amount of 1,000 mJ/cm² by a mercury lamp.

The content of the polyfunctional (meth)acrylic monomer in the active energy ray curable resin composition, which is not particularly limited and can be appropriately selected depending upon the purpose, is preferably 15.0% by mass to 99.9% by mass, more preferably 50.0% by mass to 99.0% by mass, and particularly preferably 75.0% by mass to 98.0% by mass.

### Photopolymerization Initiator

Examples of the photopolymerization initiator include a photoradical polymerization initiator, a photo-acid generating agent, a bisazido compound, hexamethoxymethylmelamine, and tetramethoxy glycoluril.

Examples of the photoradical polymerization initiator, which is not particularly limited and can be appropriately selected depending upon the purpose, include ethoxyphenyl(2,4,6-trimethylbenzoyl)phosphine oxide, bis(2,6-dimethylbenzoyl)-2,4,4-trimethylpentylphosphine oxide, bis(2,4,6-trimethylbenzoyl)-2,4,4-trimethylpentylphosphine oxide, bis(2,6-dichlorobenzoyl)-2,4,4-trimethylpentylphosphine oxide, 1-phenyl-2-hydroxy-2-methylpropan-1-on, 1-hydroxycyclohexylphenyl ketone, 1-(4-isopropylphenyl)-2-hydroxy-2-methylpropan-1-on, 1,2-diphenylethanedione and methylphenylglyoxylate.

The content of the photopolymerization initiator in the active energy ray curable resin composition, which is not particularly limited and can be appropriately selected depending upon the purpose, is preferably 0.1% by mass to 10% by mass, more preferably 0.5% by mass to 8% by mass, and particularly preferably 1% by mass to 5% by mass.

### Other Components

Examples of the other components, which are not particularly limited and can be appropriately selected depending upon the purpose, include a filler.

The filler sometimes used for controlling elongation percentage and hardness, etc. of the lipophilic resin layer.

Examples of the filler, which is not particularly limited and can be appropriately selected depending upon the purpose, include silica, zirconia, titania, tin oxide, indium tin oxide, antimony-doped tin oxide, and antimony pentoxide. Examples of the silica include solid silica and hollow silica.

The active energy ray curable resin composition may be diluted with an organic solvent and put in use. Examples of the organic solvent include an aromatic solvent, an alcohol solvent, an ester solvent, a ketone solvent, a glycol ether solvent, a glycol ether ester solvent, a chlorine solvent, an ether solvent, N-methylpyrrolidone, dimethylformamide, dimethylsulfoxide and dim ethylacetamide.

The active energy ray curable resin composition is cured by irradiation of an active energy ray. Examples of the active energy ray, which is not particularly limited and can be appropriately selected depending upon the purpose, include an electron beam, a UV ray, an infrared ray, a laser beam, a visible ray, ionizing radiation (X ray, an α ray, a β ray, a γ ray, etc.), a microwave and a high-frequency wave.

The Martens hardness of the lipophilic resin layer, which is not particularly limited and can be appropriately selected depending upon the purpose, is preferably 50 N/mm² to 300 N/mm², more preferably 100 N/mm² to 250 N/mm², and particularly preferably 150 N/mm² to 230 N/mm². In molding process of the lipophilic laminate, more specifically, in injection molding of a polycarbonate, a lipophilic laminate is heated and pressed at 290° C. and at a pressure of 200 MPa. At this time, micro convex portions or micro concave portions in the surface of the lipophilic resin layer sometimes deform. For example, the height of the micro convex portions decreases and the depth of micro concave portions decreases. Deformation is acceptable as long as fingerprint resistance is not affected; however, if deformation is excessively large, the oleic acid contact angle increases and the fingerprint resistance deteriorates. If the Martens hardness is less than 50 N/mm², micro convex portions or micro concave portions in the surface of the lipophilic resin layer is excessively deformed in a molding process of the lipophilic laminate, the oleic acid contact angle increases and fingerprint resistance deteriorates. In addition, the lipophilic resin layer is easily cracked in handling during a production or molding process of the lipophilic laminate and in surface cleaning during ordinary use. In contrast, if the Martens hardness exceeds 300 N/mm², the lipophilic resin layer is sometimes cracked and peels during a molding process. It is advantageous that the Martens hardness falls within the particularly preferable range, since the lipophilic laminate can be easily molded into various three-dimensional shapes without deteriorating fingerprint resistance and without producing defects such as a scratch, a crack, or peeling.

Note that after the molding process of the lipophilic laminate, since high temperature and high pressure are applied to the lipophilic resin layer in the injection molding step, the Martens hardness of the lipophilic resin layer sometimes increases than before the molding process.

The Martens hardness can be measured, for example, by means of PICODENTOR HM500 (trade name; manufactured by Fischer Instruments K.K.) by applying a load (1 mN/20 s) and using a diamond cone as a needle, at a face angle of 136°.

The pencil hardness of the lipophilic resin layer, which is not particularly limited and can be appropriately selected depending upon the purpose, is preferably B to 4H, more preferably HB to 4H, and particularly preferably F to 4H. If the pencil hardness is less than B (softer than B), the lipophilic resin layer is easily cracked in handling during a production or molding process of the lipophilic laminate and in surface cleaning during ordinary use. In addition, in a molding process of the lipophilic laminate, micro convex portions or micro concave portions in the surface of the lipophilic resin layer excessively deforms, with the result that oleic acid contact angle increases and fingerprint resistance sometimes deteriorates. In contrast, if the pencil hardness exceeds 4H (harder than 4H), the lipophilic resin layer sometimes cracks and peels during a molding process. It is advantageous that the pencil hardness falls within the particularly preferable range, since the lipophilic laminate can be easily molded into various three-dimensional shapes without deteriorating fingerprint resistance and without producing defects such as a scratch, a crack, or peeling.

Note that after the molding process of the lipophilic laminate, since high temperature and high pressure are applied to the lipophilic resin layer in the injection molding step, the pencil hardness of the lipophilic resin layer sometimes increases than before the molding process.

The pencil hardness is measured in accordance with JIS K 5600-5-4.

The average thickness of the lipophilic resin layer, which is not particularly limited and can be appropriately selected depending upon the purpose, is preferably 1 μm to 100 μm, more preferably 1 μm to 50 μm, and particularly preferably 1 μm to 30 μm.

### Other Members

As the other members, an anchor layer, a protection layer, an adhesion layer, an adhesive layer etc. are mentioned.

### Anchor Layer

The anchor layer is a layer which is provided between the substrate made of a resin and the lipophilic resin layer.

Owing to the presence of the anchor layer, adhesion between the substrate made of a resin and the lipophilic resin layer can be improved.

The refractive index of the anchor layer is preferably close to the refractive index of the lipophilic resin layer in order to prevent interference irregularity. For this reason, the refractive index of the anchor layer falls preferably within ±0.10 of the refractive index of the lipophilic resin layer and more preferably within ±0.05. Alternatively, the refractive index of the anchor layer is preferably between the refractive index of the lipophilic resin layer and the refractive index of the substrate made of a resin.

The anchor layer can be formed by applying, for example, an active energy ray curable resin composition. As the active energy ray curable resin composition, for example, an active energy ray curable resin composition containing at least urethane (meth)acrylate and a photopolymerization initiator, and further containing other components as necessary is mentioned. As the urethane (meth)acrylate and the photopolymerization initiator, the same examples of the difunctional urethane (meth)acrylates and the photopolymerization initiators as described in the section where the lipophilic resin layer is explained, are respectively mentioned. Examples of the application method for coating, which is not particularly limited and can be appropriately selected depending upon the purpose, include wire bar coating, blade coating, spin coating, reverse roll coating, die coating, spray coating, roll coating, gravure coating, microgravure coating, lip coating, air knife coating, curtain coating, a comma coat method and a dipping method.

The average thickness of the anchor layer, which is not particularly limited and can be appropriately selected depending upon the purpose, is preferably 0.01 μm to 10 μm, more preferably 0.1 μm to 5 μm, and particularly preferably 0.3 μm to 3 μm.

Note that a reflectivity-reducing function and an antistatic function may be imparted to the anchor layer.

### Protection Layer

The protection layer is not particularly limited and can be appropriately selected depending upon the purpose, as long as it is formed on the lipophilic resin layer, and it prevents the lipophilic resin layer from being damaged during a production or molding process of the lipophilic laminate. The protection layer is peeled off when the lipophilic laminate is used.

### Adhesion Layer, Adhesive Layer

The adhesion layer and the adhesive layer is not particularly limited and can be appropriately selected depending upon the purpose, as long as they are formed on the substrate made of a resin, and they are layers for allowing the lipophilic laminate to adhere to a work piece or a adherend.

The elongation percentage of the lipophilic laminate, which is not particularly limited and can be appropriately selected depending upon the purpose, is preferably 10% or more, more preferably 10% to 200% and particularly preferably 40% to 150%. If the elongation percentage is less than 10%, it is sometimes difficult to perform molding processing. It is advantageous that the elongation percentage falls within the particularly preferable range since molding processability is excellent.

The elongation percentage can be obtained, for example, by the following method.

The lipophilic laminate is cut into rectangular pieces of 10.5 cm in length×2.5 cm in width and used as measurement samples. The tension-elongation percentage of the measurement samples obtained is measured by a tension-tester (AUTOGRAPH AG-5KNX PLUS, manufactured by Shimadzu Corporation) in measurement conditions (tension rate=100 mm/min; distance between chucks=8 cm). The elongation percentage is measured with the measurement samples being visually observed and determined at the time point immediately before the lipophilic laminate is cracked. This procedure is repeated with respect to measurement samples (N=5) and the average value of them is regarded as the elongation percentage of the lipophilic laminate. Note that, a value of the elongation percentage has only to fall within the above range as measured at room temperature (25° C.) or the softening point of the substrate made of a resin.

It is preferable that the lipophilic laminate has a small difference in the in-plane heat shrinkage rate between the X direction and the Y direction. The X direction and the Y direction of the lipophilic laminate are defined as follows. For example, if the lipophilic laminate is a roll, the X direction and the Y direction correspond to the longitudinal direction and the width direction of the roll, respectively. It is preferable that the difference in the heat shrinkage rate between the X direction and the Y direction of the lipophilic laminate at the heating temperature employed in the heating step during molding, falls within 5%. If the difference is outside the range, the lipophilic resin layer is peeled and cracked during a molding process, and letters, patterns and images printed on the surface of a substrate made of a resin deform or shift in position, with the result that it becomes sometime difficult to apply a molding process.

The lipophilic laminate is a film particularly suitable for in-mold forming, insert molding, and overlay molding.

A method for manufacturing the lipophilic laminate is not particularly limited and can be appropriately selected depending upon the purpose. Examples of the method include the following first method, the following second method, and a method for manufacturing a lipophilic laminate of the present invention described below. Among them, the method for manufacturing a lipophilic laminate of the present invention described below is preferable. Note that, the second method is a method for manufacturing a lipophilic resin body in which the lipophilic resin layer is integrally formed with the substrate made of a resin. Thus, in the present invention, the lipophilic resin layer may be integrally formed with the substrate made of a resin. That is, the lipophilic resin body has micro convex portions or micro concave portions in a surface thereof, and has the oleic acid contact angle of the surface of 10° or less.

### First Method

The first method is a method in which a substrate made of a resin having micro convex portions or micro concave portions in a surface thereof is produced, following by forming a lipophilic resin layer following the micro convex portions or micro concave portions on the surface having the micro convex portions or micro concave portions of the substrate made of a resin.

Specifically, in the first method, a melt extrusion method or a transfer method may be used. As the melt extrusion method, mentioned is a method in which a thermoplastic resin composition is ejected from a die to form a film, and, immediately thereafter, the film is nipped between two rollers to transfer a surface shape of the rollers onto the substrate made of a resin which is formed of the thermoplastic resin composition. As the transfer method, mentioned is a thermal transfer method in which a molding surface having micro convex portions or concave portions of a matrix is pressed against a substrate made of a resin, followed by heating to a temperature around or higher than the glass transition temperature thereof to thereby transfer a shape of the molding surface of the matrix onto a surface of the substrate made of a resin.

Then, the active energy ray curable resin composition for forming a lipophilic resin layer is applied onto the surface having micro convex portions or concave portions of the substrate made of a resin, and then, is irradiated with an active energy ray to cure, to thereby form a lipophilic resin layer following the micro convex portions or micro concave portions.

### Second Method

The second method is a method for manufacturing a lipophilic resin body in which the lipophilic resin layer is integrally formed with the substrate made of a resin. As the second method, mentioned is a method in which a substrate made of a resin itself having micro convex portions or micro concave portions produced by the melt extrusion method or the transfer method described for the first method is used as a lipophilic resin body.

### Method for Manufacturing Lipophilic Laminate

A method for manufacturing a lipophilic laminate of the present invention includes at least: an uncured resin layer forming step, and a lipophilic resin layer forming step; and further includes other steps as necessary.

The method for manufacturing the lipophilic laminate is a method for manufacturing the lipophilic laminate of the present invention.

### Uncured Resin Layer Forming Step

The uncured resin layer forming step is not particularly limited and can be appropriately selected depending upon the purpose, as long as the step is a step of applying an active energy ray curable resin composition to a substrate made of a resin to form an uncured resin layer.

Examples of the substrate made of a resin, which is not particularly limited and can be appropriately selected depending upon the purpose, include examples of the substrate made of a resin described in the section where the lipophilic laminate of the present invention is explained.

Examples of the active energy ray curable resin composition, which is not particularly limited and can be appropriately selected depending upon the purpose, include examples of the active energy ray curable resin composition described in the section where the lipophilic resin layer for the lipophilic laminate of the present invention is explained.

The uncured resin layer is formed by applying the active energy ray curable resin composition to the substrate made of a resin and drying the composition as necessary. The uncured resin layer may be a solid film or a film having flowability due to a curable component of low molecular weight contained in the active energy ray curable resin composition.

Examples of the application method for coating, which is not particularly limited and can be appropriately selected depending upon the purpose, include wire bar coating, blade coating, spin coating, reverse roll coating, die coating, spray coating, roll coating, gravure coating, microgravure coating, lip coating, air knife coating, curtain coating, a comma coat method and a dipping method.

The uncured resin layer remains uncured since the layer is not irradiated with an active energy ray.

In the uncured resin layer forming step, if an anchor layer is formed on the substrate made of a resin, the active energy ray curable resin composition may be applied to the anchor layer to form the uncured resin layer.

Examples of the anchor layer, which is not particularly limited and can be appropriately selected depending upon the purpose, include examples of the anchor layers described in the section where the lipophilic laminate of the present invention is explained.

Lipophilic Resin Layer Forming Step

The lipophilic resin layer forming step is not particularly limited and can be appropriately selected depending upon the purpose as long as the step is a step of forming a lipophilic resin layer by bringing a transfer matrix having micro convex portions or micro concave portions into contact with the uncured resin layer, and irradiating the uncured resin layer in contact with the transfer matrix with an active energy ray to cure the uncured resin layer, thereby transferring the micro convex portions or the micro concave portions.

### Transfer Matrix

The transfer matrix has micro convex portions or micro concave portions.

The material, size and structure of the transfer matrix are not particularly limited and can be appropriately selected depending upon the purpose.

A method for forming micro convex portions or micro concave portions of the transfer matrix, which is not particularly limited and can be appropriately selected depending upon the purpose, is preferably etching of the surface of the transfer matrix with a photoresist having a predetermined pattern shape used as a protection film, or laser processing of the transfer matrix by irradiating the surface of the transfer matrix with a laser.

### Active Energy Ray

The active energy ray is not particularly limited and can be appropriately selected depending upon the purpose, as long as the uncured resin layer can be cured by the active energy ray. Examples of the active energy ray include those described in the section where the lipophilic laminate of the present invention is explained.

Herein, specific examples of the lipophilic resin layer forming step will be described with reference to drawings.

### First Embodiment

The first embodiment is an example of the lipophilic resin layer forming step performed by using a transfer matrix having micro convex portions or micro concave portions which are formed by etching a surface of a transfer matrix with a photoresist having a predetermined pattern shape used as a protection film.

First, a transfer matrix and a method for manufacturing the transfer matrix will be described.

### Structure of Transfer Matrix

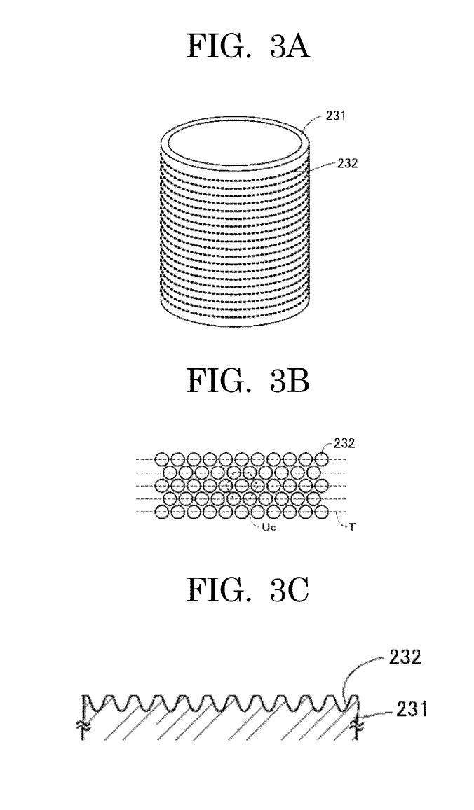

FIG. 3A is a perspective view showing a structure of a roll matrix serving as a transfer matrix. FIG. 3B is a magnified plan view of a part of the roll matrix shown in FIG. 3A. FIG. 3C is a sectional view taken along the line of track T in FIG. 3B. A roll matrix 231 is a transfer matrix for use in preparing a lipophilic laminate having the aforementioned constitution, and more specifically is a matrix for molding a plurality of convex portions or concave portions in the surface of the lipophilic resin layer. The roll matrix 231 has, for example, a columnar or cylindrical shape and the columnar surface or cylinder surface serves as a molding surface for forming a plurality of convex portions or concave portions on the surface of a lipophilic resin layer. In the molding surface, for example, a plurality of structures 232 are two-dimensionally arranged. In FIG. 3C, the structure 232 has a concave state relative to the molding surface. As the material for the roll matrix 231, for example, glass can be used; however the material is not particularly limited to glass.

A plurality of structures 232 arranged in the molding surface of the roll matrix 231 and a plurality of convex portions or concave portions arranged in the surface of the lipophilic resin layer have mutually inverted convexoconcave patterns. To be more specific, the array, size, shape, arrangement pitch, height or depth and aspect ratio, etc. of the structures 232 of the roll matrix 231 are identical with those of the convex portions or concave portions of the lipophilic resin layer.

### Roll-Matrix Exposure Apparatus

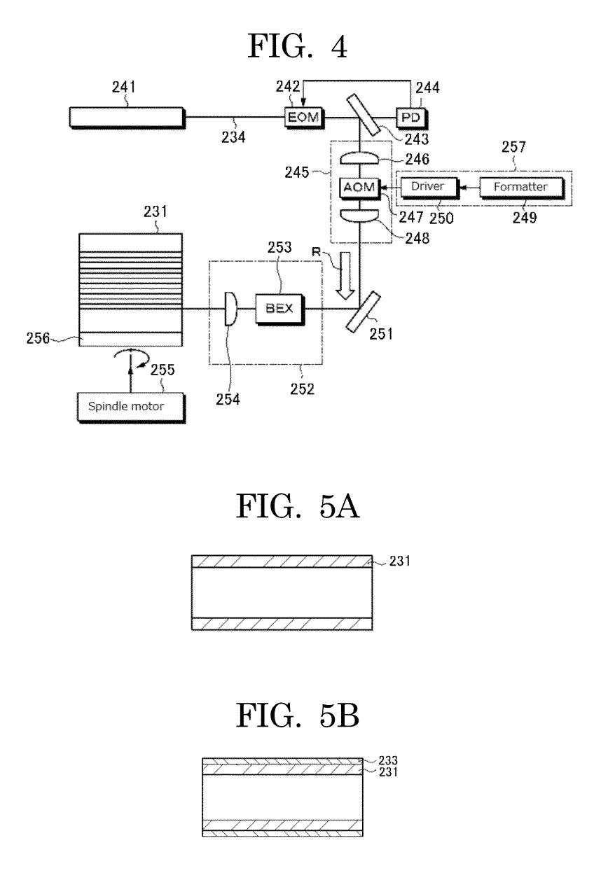

FIG. 4 is a schematic view showing a structure of a roll-matrix exposure apparatus for preparing a roll matrix. The roll-matrix exposure apparatus is constituted based on an optical disk recording apparatus.

A laser beam source 241 is a light source for exposing with light a resist applied to the surface of the roll matrix 231 as a recording medium, and emits, for example, a laser beam 234 having a wavelength of λ=266 nm, for recording. The laser beams 234 emitted from the laser beam source 241 linearly proceed while maintaining parallel state, and enter an electro optical modulator (EOM) 242. The laser beam 234 passed through the electro optical modulator 242 is reflected by a mirror 243 and guided into an optical modulation system 245.

The mirror 243, which is constituted of a polarization beam splitter, has a function of reflecting one of polarized components and transmitting the other polarized component. The polarized component passed through the mirror 243 is received by a photodiode 244. The electro optical modulator 242 is controlled based on the received signal to perform phase modulation of the laser beam 234.

In the optical modulation system 245, the laser beam 234 is collected via a condensing lens 246 by an acousto-optic modulator (AOM) 247 formed of glass (SiO₂), etc. The laser beam 234 is modified in intensity by the acousto-optic modulator 247 and emitted, and then, changed into parallel beams by a lens 248. The laser beam 234 emitted from the optical modulation system 245 is reflected by a mirror 251 and guided onto a movable optical table 252 horizontally in parallel.

The movable optical table 252 has a beam expander 253 and an objective lens 254. The laser beam 234 guided to the movable optical table 252 is shaped into a desired beam shape by the beam expander 253, and emitted via the objective lens 254 to the resist layer on the roll matrix 231. The roll matrix 231 is placed on a turn table 256 connected to a spindle motor 255. While rotating the roll matrix 231 and simultaneously moving the laser beam 234 in the height direction of the roll matrix 231, the resist layer formed on the peripheral side surface of the roll matrix 231 is intermittently irradiated with the laser beam 234. In this manner, a step of exposing the resist layer with light is carried out. The formed latent image has a substantially ellipsoid shape having a major axis along the circumferential direction. The laser beam 234 is moved by moving the movable optical table 252 in the direction indicated by arrow R.

The light exposure apparatus has a control mechanism 257 for forming latent images corresponding to a two-dimensional pattern of the aforementioned convex portions or concave portions, on the resist layer. The control mechanism 257 has a formatter 249 and a driver 250. The formatter 249 has a polarity reversion portion. The polarity reversion portion controls application timing of the laser beam 234 to the resist layer. The driver 250 controls the acousto-optic modulator 247 in response to output of the polarity reversion portion.

In the roll-matrix exposure apparatus, so as to spatially link the two-dimensional patterns, a signal is generated track by track by operating the polarity reversion formatter in synchronism with a rotation controller. In this manner, the intensity is modified by the acousto-optic modulator 247. Patterning is performed at a constant angular velocity (CAV), an appropriate rotation number, an appropriate modulation frequency, and an appropriate feed pitch. In this manner, a two-dimensional pattern such as a hexagonal lattice pattern can be recorded.

### Resist Film Formation Step

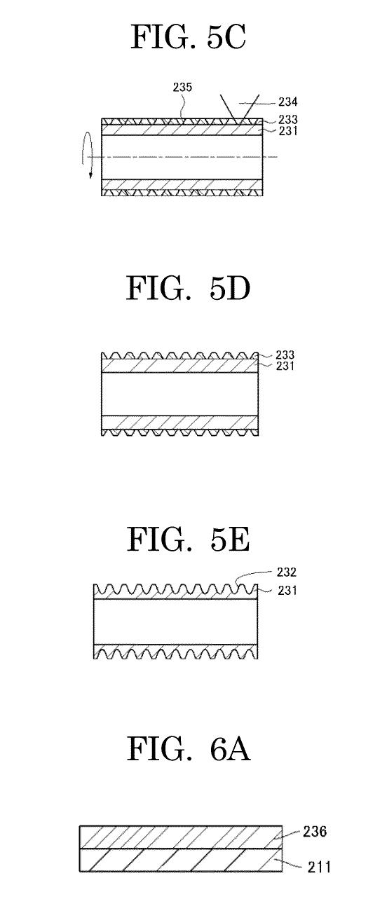

First, as shown in the sectional view of FIG. 5A, a columnar or cylindrical roll matrix 231 is prepared. The roll matrix 231 is, for example, a glass matrix. Next, as shown in the sectional view of FIG. 5B, a resist layer (for example, photoresist) 233 is formed on the surface of the roll matrix 231. Examples of the material for the resist layer 233 include organic resists and inorganic resists. Examples of the organic resists include a Novolak resist and a chemical amplification resist. Examples of the inorganic resist include metal compounds.

### Light Exposure Step

Next, as shown in the sectional view of FIG. 5C, the resist layer 233 formed on the surface of the roll matrix 231 is irradiated with the laser beam (light exposure beam) 234. To describe more specifically, on the turn table 256 of the roll-matrix exposure apparatus shown in FIG. 4, the roll matrix 231 is placed. The roll matrix 231 is rotated; at the same time, the resist layer 233 is irradiated with the laser beam (light exposure beam) 234. At this time, the resist layer is intermittently irradiated with the laser beam 234 while moving the laser beam 234 in the height direction (direction in parallel to the center axis of the columnar or cylindrical roll matrix 231) of the roll matrix 231 to expose the entire surface of the resist layer 233 with light. In this manner, latent images 235 are formed over the entire surface of the resist layer 233 in accordance with the track of the laser beam 234.

The latent images 235 are arranged so as to form, for example, a plurality of tracks T in the roll matrix surface; at the same time, a periodical pattern of a predetermined unit cell Uc is formed. Each of the latent images 235 has, for example, a circular or elliptical shape. If the latent image 235 has an elliptical shape, it is preferable that the elliptical shape has a major axis in parallel in the extension direction of track T.

### Development Step

Next, for example, while rotating the roll matrix 231, a developer is dripped onto the resist layer 233 to develop the resist layer 233. In this manner, as shown in the sectional view of FIG. 5D, a plurality of opening portions are formed in the resist layer 233. If the resist layer 233 is formed of a positive-type resist, the light exposure portion exposed to the laser beam 234 is increased in dissolution rate to the developer compared to non-light exposure portion. As a result, as shown in the sectional view of FIG. 5D, the pattern reflecting the latent images (light exposure portion) 235 is formed on the resist layer 233. The pattern reflecting the opening portions is, for example, a pattern where a predetermined unit cell Uc regularly and periodically appears.

### Etching Step

Next, the surface of the roll matrix 231 is etched with the pattern (resist pattern) of the resist layer 233 formed on the roll matrix 231 used as a mask. In this manner, a cone-shaped structure (concave portion) 232 can be obtained as shown in the sectional view of FIG. 5E. The cone shape is preferably an elliptical cone shape or a truncated elliptical cone shape having a major axis, for example, in parallel to the extending direction of track T. As the etching, for example, dry etching and wet etching can be used. At this time, if an etching process and an ashing process are alternately performed, for example, a pattern of the cone-shaped structure 232 can be formed. In the manner mentioned above, the desired roll matrix 231 can be obtained.

### Transfer Treatment

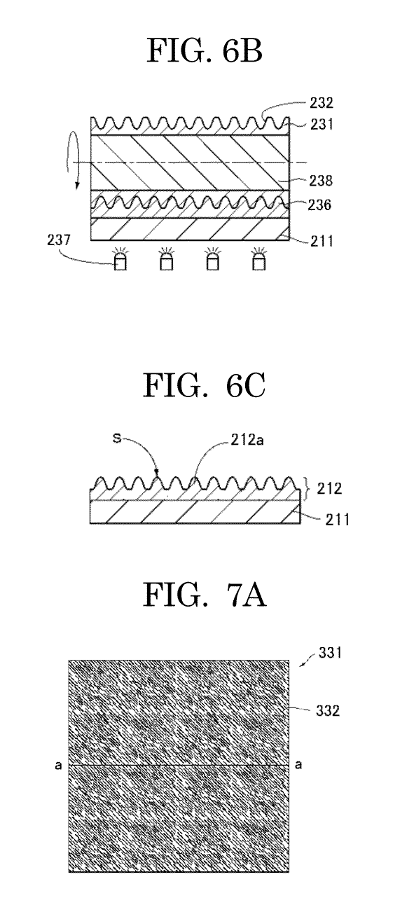

As shown in the sectional view of FIG. 6A, a substrate 211 made of a resin having an uncured resin layer 236 formed thereon is prepared.

Next, as shown in the sectional view of FIG. 6B, the roll matrix 231 is brought into contact with the uncured resin layer 236 formed on the substrate 211 made of a resin. The uncured resin layer 236 is irradiated with an active energy ray 237 to cure the uncured resin layer 236. In this manner, micro convex portions or micro concave portions is transferred to obtain a lipophilic resin layer 212 having micro convex portions or micro concave portions 212a formed therein.

Finally, the obtained lipophilic resin layer 212 is removed from the roll matrix 231 to obtain a lipophilic laminate (FIG. 6C).

Note that if the substrate 211 made of a resin is formed of a material which cannot transmit an active energy ray such as ultraviolet rays, it is possible that the roll matrix 231 is formed of a material which can transmit an active energy ray (for example, quartz) and the uncured resin layer 236 is irradiated with an active energy ray from the interior portion of the roll matrix 231. Note that the transfer matrix is not limited to the aforementioned roll matrix 231 and a flat plate-form matrix may be used. However, in view of increasing the amount of production, the aforementioned roll matrix 231 is preferably used as a transfer matrix.

### Second Embodiment

The second embodiment is an example of the lipophilic resin layer forming step performed by using a transfer matrix having micro convex portions or micro concave portions which are formed by laser processing of the transfer matrix by irradiating the surface of the transfer matrix with the laser.

First, a transfer matrix and a method for manufacturing the transfer matrix will be described.

### Structure of Transfer Matrix

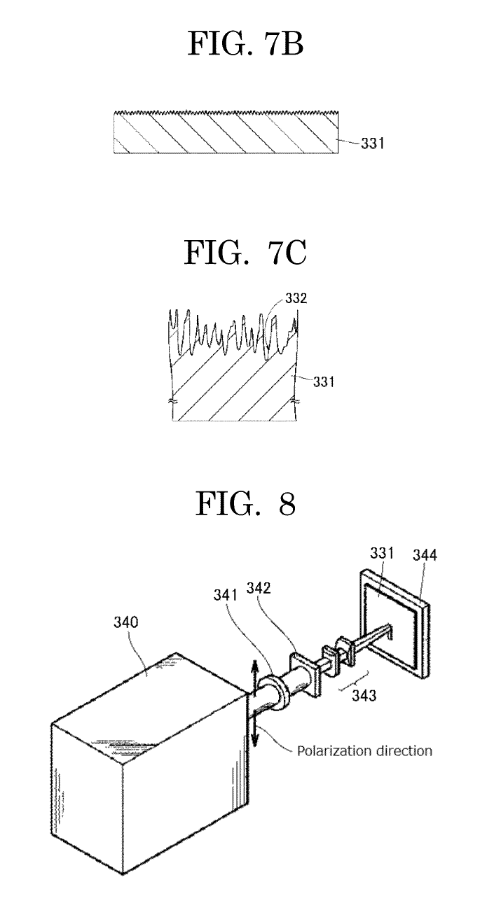

FIG. 7A is a plan view showing a structure of a plate-form matrix. FIG. 7B is a sectional view taken along the line a-a, shown in FIG. 7A. FIG. 7C is a magnified sectional view of a part of the section shown in FIG. 7B. A plate-form matrix 331 is a matrix for use in preparing a lipophilic laminate having the aforementioned constitution, more specifically, a matrix for molding a plurality of convex portions or concave portions in the surface of the lipophilic resin layer. The plate-form matrix 331 has a surface having, for example, a micro convexoconcave structure formed therein, and the surface serves as a molding surface for forming a plurality of convex portions or concave portions in the surface of a lipophilic resin layer. In the molding surface, for example, a plurality of structures 332 are provided. The structure 332 shown in FIG. 7C has a concave state relative to the molding surface. As the material for the plate-form matrix 331, for example, a metal material can be used. Examples of the metal material that can be used include Ni, NiP, Cr, Cu, Al, Fe and its alloy. As the alloy, stainless steel (SUS) is preferable. Examples of the stainless steel (SUS) include, but not limited to, SUS304 and SUS420J2.

A plurality of structures 332 provided in the molding surface of the plate-form matrix 331 and a plurality of convex portions or concave portions provided in the surface of the lipophilic resin layer have mutually inverted convexoconcave patterns. More specifically, the array, size, shape, arrangement pitch and height or depth etc. of the structures 332 of the plate-form matrix 331 are the same as those of the convex portions or concave portions of the lipophilic resin layer.

### Structure of Laser Processing Apparatus

FIG. 8 is a schematic view showing a structure of a laser processing apparatus for preparing a plate-form matrix. The laser main-body 340 is, for example, IFRIT (trade name, manufactured by Cyber Laser Inc.). The wavelength of the laser to be used for laser processing is, for example, 800 nm; however, the wavelength may be 400 nm and 266 nm etc. The repetitive frequency is preferably large in consideration of processing time and reducing the arrangement pitch between concave portions or convex portions formed, and preferably 1,000 Hz or more. The pulse width of the laser is preferably short, and preferably about 200 femto seconds (10⁻¹⁵ seconds) to about 1 pico-second (10⁻¹² seconds).

The laser main-body 340 emits laser beams linearly polarized in the vertical direction. Thus, in this apparatus, linearly polarized light in a desired direction or a circular polarized light is obtained by rotating the polarization direction by use of a wave plate 341 (for example, λ/2 wave plate). Furthermore, in this apparatus, a laser beam is partially taken out by use of an aperture 342 having a square opening, for the reason that since the intensity distribution of laser beam follows the Gaussian distribution, if the center portion of the laser beams alone is used, a laser beam having a uniform in-plane intensity distribution is obtained. Moreover, in the apparatus, the laser beam is narrowed by use of two cylindrical lenses 343 mutually perpendicularly placed to obtain a desired beam size. In processing the plate-form matrix 331, a linear stage 344 is moved at the same speed.

The beam spot of the laser with which the plate-form matrix 331 is irradiated preferably has a square shape. The beam spot can be shaped, for example, by use of an aperture and a cylindrical lens etc. Furthermore, the intensity distribution of the beam spot is preferably as uniform as possible. This is because the in-plane distribution of the depth of convexoconcave portions to be formed in dies is obtained as uniform as possible. Generally, since the size of a beam spot is smaller than the area to be processed, it is necessary to scan the beam to form convexoconcave portions in the entire surface that is desired to be processed.

The matrix (die) for use in forming the surface of the lipophilic resin layer is formed by irradiating a substrate made of a metal such as SUS, NiP, Cu, Al and Fe with an ultrashort pulsed-laser beam having a pulse width of 1 pico-second (10⁻¹² seconds) or less, so-called a femto second laser, to draw a pattern. Polarization of a laser beam may be linear, circular, or ellipsoidal. At this time, the laser wavelength, repetitive frequency, pulse width, beam-spot shape, polarization, the intensity of a laser with which a sample is irradiated and laser scanning speed, etc., are appropriately set. In this manner, a pattern having desired convexoconcave portions can be formed.

As the parameters that can be changed in order to obtain a desired shape, the following ones are mentioned. Fluence refers to the energy density (J/cm²) per pulse and can be obtained in accordance with the following expression:

F=P/(fREPT×S)

where

S=Lx×Ly

F: Fluence

P: Power of laser

fREPT: Repetitive frequency of laser

S: Area of laser at irradiation position

Lx×Ly: Beam size

Note that the pulse number N is the number of pulses with which a single site is irradiated and obtained in accordance with the following expression.

N=fREPT×Ly/v

where

Ly: Beam size of a laser in a scanning direction

v: Scanning speed of laser

To obtain a desired shape, the material of the plate-form matrix 331 may be changed. Depending upon the material for the plate-form matrix 331, the shape processed by a laser changes. Other than the use of a metal such as SUS, NiP, Cu, Al, and Fe, a matrix surface may be coated with, for example, a semiconductor material such as DLC (diamond-like carbon). As a method for coating a matrix surface with the semiconductor material, for example, plasma CVD and sputtering are mentioned. As the semiconductor material to be applied, not only DLC but also fluorine (F) containing DLC, titanium nitride and chromium nitride, etc., can be used. The average thickness of the coating film to be obtained may be set, for example, at about 1 μm.

### Laser Processing Step

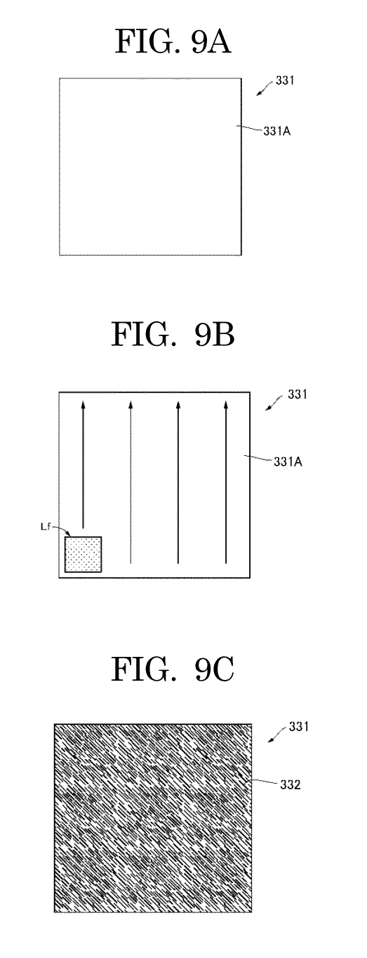

First, as shown in FIG. 9A, the plate-form matrix 331 is prepared. A surface 331A of the plate-form matrix 331 to be processed is, for example, in mirror surface state. Note that the surface 331A may not be in a mirror surface state. The surface 331A may have smaller convexoconcave portions than those in the pattern to be transferred or may have convexoconcave portions which are the same as or coarser than those in the pattern to be transferred.

Next, using the laser processing apparatus shown in FIG. 8, the surface 331A of the plate-form matrix 331 is processed by a laser as follows. First, to the surface 331A of the plate-form matrix 331, an ultrashort pulsed-laser beam having a pulse width of 1 pico-second (10⁻¹² seconds) or less, so-called a femto second laser, is applied to draw a pattern. For example, as shown in FIG. 9B, the surface 331A of the plate-form matrix 331 is irradiated with femto second laser light Lf and the irradiation spot is moved in a scanning manner on the surface 331A.

At this time, the laser wavelength, repetitive frequency, pulse width, beam-spot shape, polarization, the intensity of the laser with which the surface 331A is irradiated and laser scanning speed, etc., are appropriately set. In this manner, a plurality of structures 332 having a desired shape are formed, as shown in FIG. 9C.

### Transfer Process

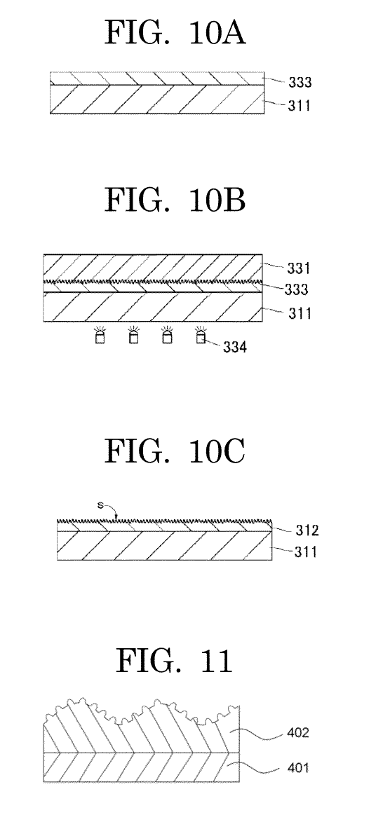

A substrate 311 made of a resin having an uncured resin layer 333 formed thereon is prepared as shown in the sectional view of FIG. 10A.

Next, as shown in the sectional view of FIG. 10B, the plate-form matrix 331 is brought into contact with the uncured resin layer 333 formed on the substrate 311 made of a resin. The uncured resin layer 333 is irradiated with an active energy ray 334 to cure the uncured resin layer 333. In this manner, micro convex portions or micro concave portions of the plate-form matrix 331 may be transferred to obtain a lipophilic resin layer 312 having micro convex portions or micro concave portions formed therein.

Finally, the lipophilic resin layer 312 thus formed is removed from the plate-form matrix 331 to obtain a lipophilic laminate (FIG. 10C).

Note that if a substrate 311 made of a resin is formed of a material which does not transmit an active energy ray such as ultraviolet rays, it is possible that the plate-form matrix 331 is formed of a material (for example, quartz), which can transmit an active energy ray, and the uncured resin layer 333 is irradiated with the active energy ray from the rear surface of the plate-form matrix 331 (the opposite surface to a molding surface).

### Third Embodiment

The third embodiment is an example of the lipophilic resin layer forming step performed by using a transfer matrix which is produced by forming a porous alumina layer on an aluminium substrate.

First, a transfer matrix and a method for manufacturing the transfer matrix will be described.

Examples of the aluminium substrate to be processed into the transfer matrix include bulk aluminium, a glass substrate, or an aluminium film formed on a plastic substrate via a primer layer.

The shape of the aluminium substrate is not particularly limited and can be appropriately selected depending upon the purpose. Examples thereof include a plate form, a cylindrical shape, and a columnar shape.

The porous alumina layer is formed by, for example, anodic oxidation or wet etching treatment.

The porous alumina layer has micro concave portions. The micro concave portions may be or may not be arranged periodically.

Example of a method for forming the porous alumina layer includes a method in which an aluminium substrate is immersed into an acidic electrolytic solution or an alkaline electrolytic solution, which is used as an anode to apply voltage to thereby form a porous alumina layer having a plurality of micro concave portions, as specifically disclosed in JP-A No. 2005-156695. This anodic oxidation treatment may be appropriately used in combination with a pore diameter enlarging treatment through an etching treatment.

The lipophilic resin layer forming step performed with the thus-produced transfer matrix may be the same as in the first embodiment and the second embodiment.

### Fourth Embodiment

The fourth embodiment is an example of the lipophilic resin layer forming step performed by using the transfer matrix which is produced by forming a macro convexoconcave structure on a surface of an aluminium substrate, followed by forming micro concave portions (micro structure) on the macro convexoconcave structure.

Example of a method for producing the transfer matrix includes a method described in JP-A No. 2001-517319.

Formation of the macro convexoconcave structure and the micro concave portions (micro structure) on the transfer matrix can impart an anti-glare function to the lipophilic laminate formed with the transfer matrix, in addition to the fingerprint resistance. The macro convexoconcave structure for imparting the anti-glare function can be formed on the surface of the aluminium substrate by, for example, a blasting processing (e.g., a sandblasting processing or a bead blasting processing), an etching processing with an acid, or both thereof. The micro concave portions (micro structure) can be formed by anodic oxidation or wet etching treatment.

The lipophilic resin layer forming step performed by using the thus-produced transfer matrix may be the same as in the first embodiment and the second embodiment.

FIG. 11 shows an example of the lipophilic laminate produced with this transfer matrix. The lipophilic laminate shown in FIG. 11 includes a substrate 401 made of a resin and a lipophilic resin layer 402 on the substrate 401 made of a resin. On a surface of the lipophilic resin layer 402, a macro convexoconcave structure and the micro concave portions formed on the macro convexoconcave structure are formed.

### Product

A product of the present invention includes the hydrophilic laminate of the present invention as a surface and further includes other members as necessary.

Examples of the product, which is not particularly limited and can be appropriately selected depending upon the purpose, include touch panels, smartphones, tablet PCs, cosmetic containers, accessories, glass windows, refrigerating/freezing show case, window materials for automobile windows, bath mirrors, mirrors such as automobile side mirrors, pianos, and construction materials.

The product may be a pair of glasses, goggles, head-gears, lenses, microlens arrays, and headlight covers, front panels, side panels, rear panels, door trims, instrument panels, center cluster/center console panels, shift knobs, members around a shift knob, steering emblems of automobiles. These are preferably formed by in-mold forming, insert molding, or overlay molding.

The lipophilic laminate may be used as a part or whole of the surface of the product.

A method for manufacturing the product is not particularly limited and can be appropriately selected depending upon the purpose; however, the method for manufacturing the product of the present invention (described later) is preferable.

### Method for Manufacturing Product

A method for manufacturing a product of the present invention at least includes a heating step, a lipophilic laminate molding step, and an injection molding step, and further includes other steps as necessary.

The method for manufacturing a product is a method for manufacturing the product of the present invention.

### Heating Step

The heating step is not particularly limited and can be appropriately selected depending upon the purpose as long as it is a step of heating a lipophilic laminate.

The lipophilic laminate is the lipophilic laminate of the present invention.

The heating is not particularly limited and can be appropriately selected depending upon the purpose; however, infrared heating is preferable.

The heating temperature is not particularly limited and can be appropriately selected depending upon the purpose; however, the heating temperature is preferably near the glass transition temperature of the substrate made of a resin or the glass transition temperature or more.

The heating time is not particularly limited and can be appropriately selected depending upon the purpose.

### Lipophilic Laminate Molding Step

The lipophilic laminate molding step is not particularly limited and can be appropriately selected depending upon the purpose as long as it is a step of molding the heated lipophilic laminate into a desired shape. For example, a step of bringing the laminate into contact with a predetermined die and molding the laminate into a desired shape by application of air pressure, is mentioned.

### Injection Molding Step

The injection molding step is not particularly limited and can be appropriately selected depending upon the purpose as long as it is a step of injecting a molding material onto a substrate made of a resin of the lipophilic laminate molded into a desired shape and molding the molding material.

As the molding material, for example, a resin is mentioned. Examples of the resin include olefin resins, styrene resins, ABS resins (acrylonitrile-butadiene-styrene copolymers), AS resins (acrylonitrile-styrene copolymers), acrylic resins, urethane resins, unsaturated polyester resins, epoxy resins, polyphenylene oxide/polystyrene resins, polycarbonates, polycarbonate modified polyphenylene ethers, polyethylene terephthalates, polysulfones, polyphenylene sulfides, polyphenylene oxides, polyetherimides, polyimides, liquid crystal polyesters, polyallyl heat-resistant resins, various types of complex resins and various types of modified resins.

The injection method is not particularly limited and can be appropriately selected depending upon the purpose. For example, a method of injecting a molten molding material to a substrate made of a resin of the lipophilic laminate which is brought into contact with a predetermined die, is mentioned.

The method for manufacturing a product is preferably performed by use of an in-mold forming apparatus, an insert-molding apparatus, or an overlay forming apparatus.

Herein, an example of method for manufacturing a product of the present invention will be described with reference to the accompanying drawings. The manufacturing method is a manufacturing method using an in-mold forming apparatus.

First, a lipophilic laminate 500 is heated. The heating is preferably performed by infrared heating.

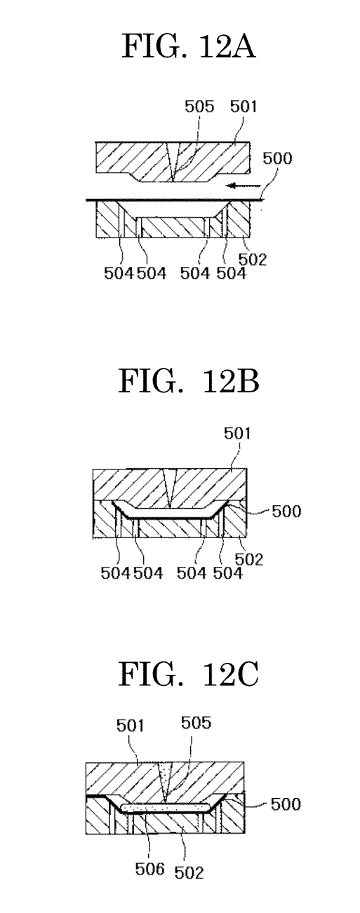

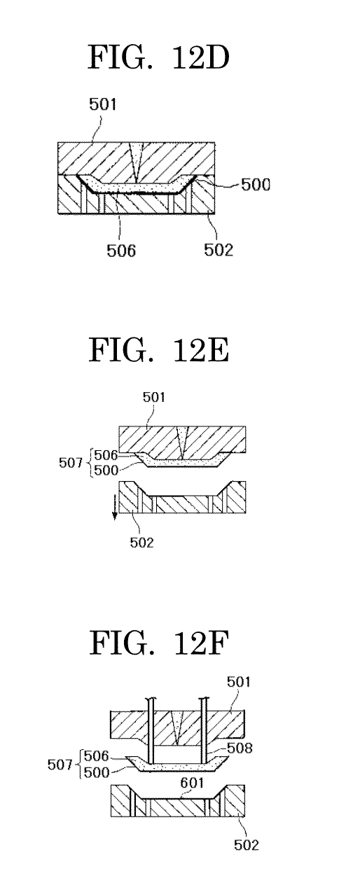

Then, as shown in FIG. 12A, the lipophilic laminate 500 heated is disposed at a predetermined position between a first die 501 and a second die 502 in such a manner that the substrate made of a resin of the lipophilic laminate 500 faces the first die 501; whereas the lipophilic resin layer faces the second die 502. In FIG. 12A, the first die 501 is immovable; whereas the second die 502 is movable.

After the lipophilic laminate 500 is disposed between the first die 501 and the second die 502, the first die 501 and the second die 502 are clamped. Subsequently, air is suctioned through a suction hole 504 having an opening in the cavity surface of the second die 502 to fit the lipophilic laminate 500 along the cavity surface of the second die 502. In this manner, the cavity surface is shaped by the lipophilic laminate 500. At this time, the periphery of the lipophilic laminate 500 may be immobilized by a film fixation mechanism (not shown) to set the lipophilic laminate. Thereafter, unnecessary portion of the lipophilic laminate 500 is trimmed away (FIG. 12B).

Note that if the second die 502 has no suction hole 504 and the first die 501 has a hole (not shown), pressurized air is fed through the hole of the first die 501 toward the lipophilic laminate 500 to fit the lipophilic laminate 500 along the cavity surface of the second die 502.

Subsequently, to the substrate made of a resin of the lipophilic laminate 500, a molten molding material 506 is injected through a gate 505 of the first die 501 and poured in the cavity, which is formed of the first die 501 and the second die 502 by clamping (FIG. 12C). In this manner, the cavity is charged with the molten molding material 506 (FIG. 12D). After completion of charge with the molten molding material 506, the molten molding material 506 is cooled to a predetermined temperature and solidified.

Thereafter, the second die 502 is moved to separate the first die 501 and the second die 502 (FIG. 12E). In this manner, the lipophilic laminate 500 is attached to the surface of the molding material 506 and a product 507 molded into a desired shape by in-mold forming can be obtained.

Finally, ejection pins 508 are pressed to remove the obtained product 507 from the first die 501.

### EXAMPLES

Now, Examples of the present invention will be described; however the present invention is not limited to these Examples.

Average distance between convex portions, average distance between concave portions, average height of convex portions, average depth of concave portions, and average aspect ratio

In the following Examples, the average distance between convex portions, average distance between concave portions, average height of convex portions, average depth of concave portions, and average aspect ratio were obtained as follows.

First, the surface of a lipophilic resin layer having convex portions or concave portions was observed by an atomic force microscope (AFM). From the section profile by the AFM, the pitch of convex portions or concave portions, and the height of the convex portions or the depth of the concave portions were obtained. This procedure was repeated with respect to 10 sites randomly selected from the surface of the lipophilic resin layer to obtain pitch P1, P2, . . . , P10 and the height or depth H1, H2, . . . , H10.

The pitch of the convex portions herein is the distance between the peaks of convex portions. The pitch of the concave portion is the distance between the deepest portions of concave portions. The height of the convex portion is the height of the convex portion based on the lowest point of the valley portion between the convex portions. The depth of the concave portion is the depth of the concave portion based on the highest point of the mount portion between the concave portions.

Then, these pitches P1, P2, . . . , P10, and height or depth H1, H2, . . . , H10 were simply averaged (arithmetic average), respectively, to obtain the average distance (Pm) of convex portions or concave portions, average height of convex portions or the average depth (Hm) of the concave portions.

Based on the value Pm and the value Hm, the average aspect ratio (Hm/Pm) was obtained.

### Space Distance of Convex Portions or Concave Portions

In the following Examples, the space distance of convex portions and concave portions, which were spaced from each other, was obtained as follows.

First, the surface S of the lipophilic resin layer was observed by a scanning electron microscope (SEM). From the SEM image of the surface, the space distance between adjacent convex portions or concave portions was obtained. The space distance is a shortest distance between outer edges of adjacent convex portions or concave portions as the surface S is viewed from above. This procedure was repeated with respect to 10 sites randomly selected from the surface of the lipophilic resin layer to obtain the space distances D1, D2, . . . , D10.

Then, these space distances D1, D2, . . . , D10 were simply averaged (arithmetic average), respectively to obtain the average space distance (Dm) of convex portions or concave portions.

### Oleic Acid Contact Angle

The oleic acid contact angle was measured use of PCA-1 (manufactured by Kyowa Interface Science Co., Ltd.) in the following conditions.

Oleic acid was placed in a plastic syringe. To the tip of the syringe, a Teflon-coated needle was attached. The oleic acid was allowed to drip on an evaluation surface.

The amount of oleic acid to be dripped: 1 μL

The measurement temperature: 25° C.

Contact angles 100 seconds after oleic acid was dripped were measured with respect to any 10 sites on the surface of the lipophilic resin layer. These contact angles were averaged to obtain the oleic acid contact angle.

### Change of Oleic Acid Contact Angle

In the above measurement method of the oleic acid contact angle, oleic acid contact angles 20 seconds and 100 seconds after oleic acid was dripped were measured with respect to any 10 sites on the surface of the lipophilic resin layer to thereby obtain the average value, respectively. The change with time of the oleic acid contact angle was calculated from the difference thereof (the average value of oleic acid contact angles 20 seconds after—the average value of oleic acid contact angles 100 seconds after).

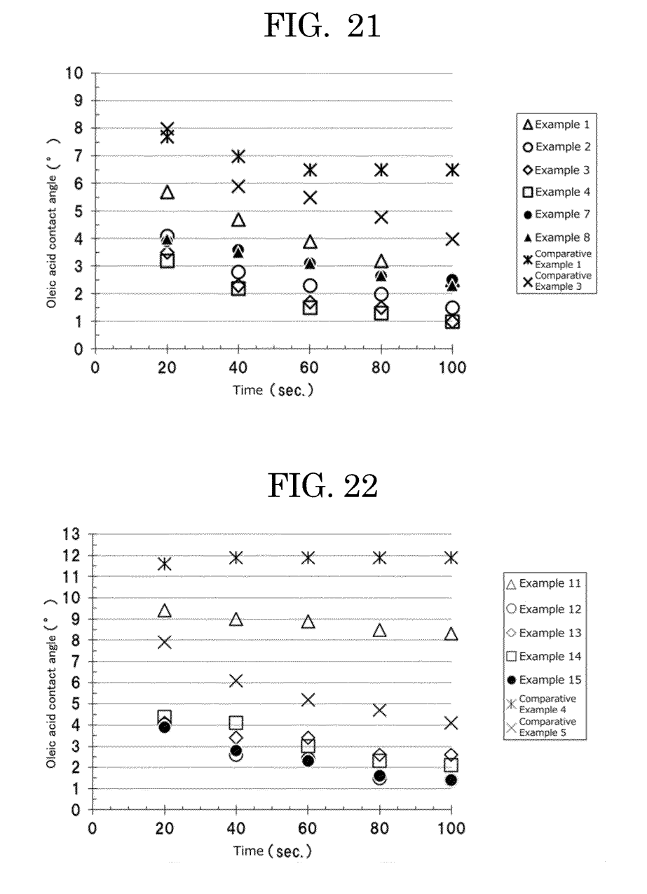

Note that, a graph showing changes of oleic acid contact angles of laminates obtained in Examples 1 to 4, 7, and 8, and Comparative Examples 1 and 3 is shown in FIG. 21; and a graph showing changes of oleic acid contact angles of laminates obtained in Examples 11 to 15, and Comparative Examples 4 and 5 is shown in FIG. 22.

### Martens Hardness

The Martens hardness of the lipophilic resin layer was measured by use of PICODENTOR HM500 (trade name; Fischer Instruments K.K.). Measurement was performed by applying a load (1 mN/20 s) and using a diamond cone as a needle and at a face angle of 136°.

### Pencil Hardness

The pencil hardness of the lipophilic resin layer was measured in accordance with JIS K 5600-5-4.

### Elongation Percentage

The elongation percentage was obtained by the following method.

The lipophilic laminate was cut into rectangular pieces of 10.5 cm in length×2.5 cm in width and used as measurement samples. The tension-elongation percentage of the measurement sample obtained was determined by a tension-tester (AUTOGRAPH AG-5KNX PLUS, manufactured by Shimadzu Corporation) in measurement conditions: (tension rate=100 mm/min; distance between chucks=8 cm, measurement temperature=190° C.). The elongation percentage was measured with the measurement sample being visually observed, and determined at the time point immediately before the lipophilic laminate was cracked. This procedure was repeated with respect to measurement samples (N=5) and the average value of them was regarded as the elongation percentage of the lipophilic laminate.

In the case where the substrate made of a resin was DF02U (PMMA/PC lamination, average thickness: 125 μm, manufactured by Mitsubishi Gas Chemical Co., Inc.), the measurement was performed at 190° C.

In the case where the substrate made of a resin was SOFT SHINE TA009 (average thickness: 125 μm, manufactured by TOYOBO CO., LTD.), the measurement was performed at 25° C.

### Total Light Transmittance

The total light transmittance of the lipophilic laminate was evaluated in accordance with JIS K 7361 and by use of HM-150 (trade name; manufactured by MURAKAMI COLOR RESEARCH LABORATORY Co., Ltd).

### Haze

The haze of the lipophilic laminate was evaluated in accordance with JIS K 7136 and by use of HM-150 (trade name; manufactured by MURAKAMI COLOR RESEARCH LABORATORY Co., Ltd).

### Adhesion

The adhesion of the lipophilic resin layer was evaluated by a grid (1 mm interval×100 cells) cellophane tape (CT24, manufactured by NICHIBAN Co., Ltd.) peel test in accordance with JIS K 5400.

### Difference in Heat Shrinkage Rate

Difference in heat shrinkage rate of the lipophilic laminate was obtained by the following method.

First, square test pieces having a size of 100 mm×100 mm were cut out such that the longitudinal direction and transverse direction of the test pieces match the longitudinal direction and width direction of the substrate made of a resin, respectively. Subsequently, these test pieces were heated in an oven at 190° C. for 30 minutes, taken out from the oven and naturally cooled to room temperature. Thereafter, the length of the test pieces in the longitudinal direction and transverse direction were measured by a ruler. Change rates of the lengths of both directions were calculated respectively based on the length (=100 mm) of a test piece before heating and an absolute value of the difference between the change rates was obtained. This procedure was repeated with respect to test pieces (N=10) and the average value of them was regarded as the difference in heat shrinkage rate of the lipophilic laminate.

### Example 1

### Preparation of Transfer Matrix (Glass Roll Matrix) Having Micro Convex Portions or Micro Concave Portions

Firstly, a glass roll matrix having an outer diameter of 126 mm was prepared, and a resist layer was formed on the surface of the glass roll matrix in the following manner. Namely, a photoresist was diluted 1/10 by mass ratio with a thinner, and the diluted resist was applied to the cylindrical surface of the glass roll matrix in an average thickness of about 70 nm by a dipping method to form a resist layer. Next, the glass roll matrix was conveyed to an exposure apparatus for a roll matrix shown in FIG. 4, the resist layer was exposed, and thereby latent images lying in a spiral manner and forming a hexagonal lattice pattern between adjacent three rows of tracks was patterned on the resist layer. Specifically, an exposure pattern having a hexagonal lattice shape was formed by applying a 0.50 mW/m laser beam to a region where the exposure pattern having a hexagonal lattice shape to be formed.

Next, development processing was applied to the resist layer on the glass roll matrix, and the development was carried out by dissolving the resist layer of the exposed part. Specifically, the undeveloped glass roll matrix was mounted on a turntable of the developing apparatus not shown in the figure, developing solution was dropped on the surface of the glass roll matrix while the glass roll matrix was rotated with the turntable, and the resist layer on the surface of the glass roll matrix was developed. Thereby, a resist glass matrix in which the resist layer is open in a hexagonal lattice pattern was obtained.

Next, plasma etching was carried out under a CHF₃ gas atmosphere using a roll etching apparatus. Thereby, etching progressed at only the hexagonal lattice pattern part exposed from the resist layer on the surface of the glass roll matrix, and the other regions were not etched because the resist layer worked as a mask, and concave portions having an elliptic cone shape were formed on the glass roll matrix. In the etching, the amount of etching (depth) was adjusted by the etching time. Finally, a glass roll matrix having a concave shaped hexagonal lattice pattern was obtained by removing the resist layer completely by O₂ ashing.

### Preparation of Lipophilic Laminate

Next, a lipophilic laminate was prepared using the roll matrix obtained in the manner described above by a UV imprint. Specifically, the preparation was carried out in the following manner.

As a substrate made of a resin, DF02U (PMMA/PC lamination, average thickness: 125 μm, manufactured by Mitsubishi Gas Chemical Co., Inc.) was used.

An ultraviolet curable resin composition for an anchor layer having the following formulation was applied to the PMMA surface of the substrate made of a resin so that the average thickness after drying and curing became 0.7 μm.

### Ultraviolet Curable Resin Composition for Anchor Layer

| | | |
|---|---|---|
| CN985B88 (aliphatic urethane acrylate, manu- | 15 | parts by mass |
| factured by Sartomer Company, Inc.) | | |
| A-9300-1CL (isocyanuric acid-containing tri- | 15 | parts by mass |
| acrylate, manufactured by Shin-Nakamura | | |
| Chemical Co., Ltd) | | |
| Butyl acetate | 68.8 | parts by mass |
| IRGACURE 184 (manufactured by Ciba | 0.6 | parts by mass |
| Specialty Chemicals Inc.) | | |
| IRGACURE 907 (manufactured by Ciba | 0.6 | parts by mass |
| Specialty Chemicals Inc.) | | |
| KP 323 (manufactured by Shin-Etsu Chemical | 0.003 | parts by mass |
| Co., Ltd.) | | |

After drying, the uncured anchor layer was irradiated with an ultraviolet ray having an irradiation amount of 1,000 mJ/cm² by a mercury lamp to obtain an ultraviolet cured substrate made of a resin and having an anchor layer.

An ultraviolet curable resin composition for a lipophilic resin layer having the following formulation was applied to the anchor layer of the substrate made of a resin and having an anchor layer so that the average thickness of the lipophilic resin layer to be obtained became 3.2 μm. The substrate made of a resin and having an anchor layer to which substrate the ultraviolet curable resin composition for a lipophilic resin layer was applied and the roll matrix obtained in the manner as described above were brought into contact, and the lipophilic resin layer was cured by irradiating an ultraviolet ray from the side of the substrate made of a resin at an irradiation amount of 1,500 mJ/cm² using a metal halide lamp. Thereafter, the lipophilic layer was peeled from the roll matrix.

### Ultraviolet Curable Resin Composition for Lipophilic Resin Layer

| | |
|---|---|
| CN985B88 (aliphatic urethane acrylate, manufactured | 95 parts by mass |
| by Sartomer Company, Inc.) | |
| LUCIRIN TPO (manufactured by BASF) | 5 parts by mass |

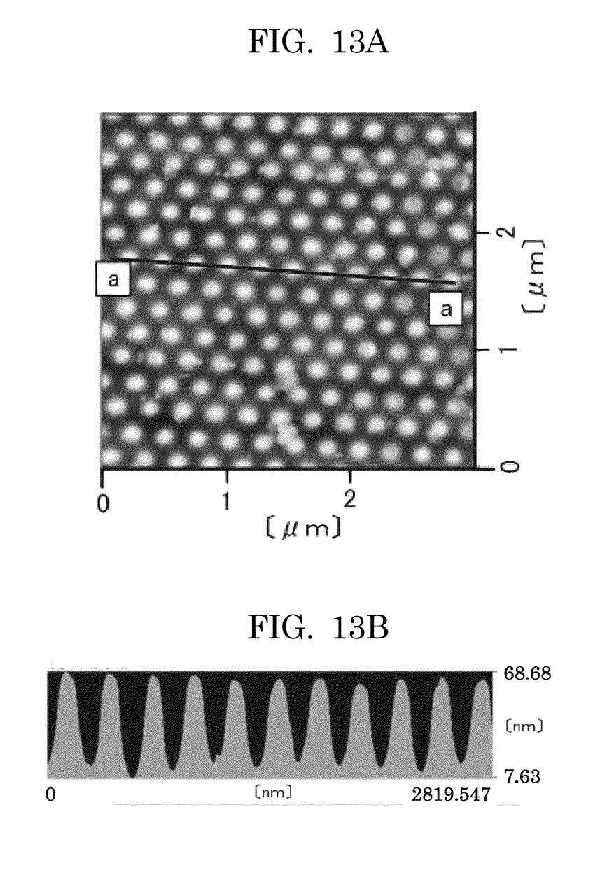

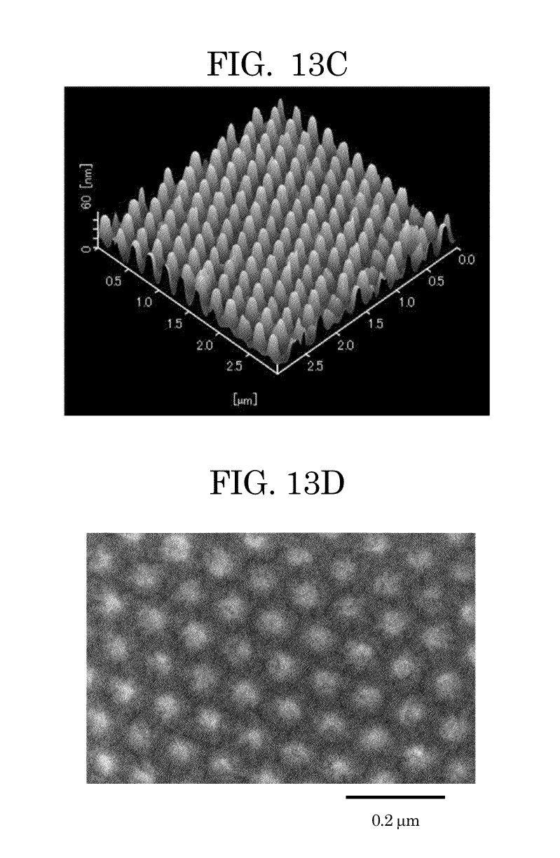

A lipophilic laminate having micro convex portions on the surface of a lipophilic layer was obtained in the manner as described above. An AFM image of a surface of the lipophilic resin layer of the obtained lipophilic laminate is shown in FIG. 13A. A cross sectional view along the a-a line in FIG. 13A is shown in FIG. 13B. A three-dimensional AFM image of the lipophilic resin layer is shown in FIG. 13C. A SEM image of the lipophilic resin layer is shown in FIG. 13D.

The average distance of the convex portions (or the average distance of the concave portions) (Pm), the average height of the convex portions (or the average depth of the concave portions) (Hm), the average aspect ratio (Hm/Pm), the average distance of the convex portions (Dm), the oleic acid contact angle, the change of the oleic acid contact angle, the Martens hardness, the pencil hardness, the elongation percentage, the total light transmittance, the haze, the adhesion, and the difference in heat shrinkage rate of the obtained lipophilic laminate were measured by the methods as described above. The results are shown in Table 2.

Moreover, the following evaluation was carried out. The results are shown in Table 3.

### Fingerprint Resistance

The lipophilic laminate was adhered to a black acrylic plate (trade name: ACRYLITE, manufactured by MITSUBISHI RAYON CO., LTD.) with a double-sided adhesive sheet (trade name: LUCIACS CS9621T, manufactured by Nitto Denko Corporation) so that an evaluation surface thereof (lipophilic resin layer-side surface) faces upward. Then, a fingerprint is deposited with an index finger to the evaluation surface, followed by evaluating for inconspicuousness of the deposited fingerprint, wiping-out property with a finger, and wiping-out property with a tissue.

### Inconspicuousness of Deposited Fingerprint

A fingerprint was deposited with an index finger onto a surface of the lipophilic resin layer. One minute thereafter, the surface was visually observed for the deposited fingerprint while illuminating the surface with a fluorescent light to thereby evaluate according to the following criteria.

### Evaluation Criteria

A: The fingerprint spread in wet condition, and became inconspicuous.

B: The fingerprint spread in wet condition, but a region onto which the fingerprint was deposited was visually observed.

C: The fingerprint insufficiently spread in wet condition, and the fingerprint including even its pattern was clearly observed.

Wiping-Out Property with Finger

A fingerprint was repeatedly deposited with an index finger onto a surface of the lipophilic resin layer for 20 times. The deposited fingerprints were wiped-out with the index finger by moving back and forth it for 10 times, and then visually observed while illuminating the surface with a fluorescent light to thereby evaluate according to the following criteria.

### Evaluation Criteria

A: No fingerprint dirt was lest.

B: The fingerprint dirt was slightly left.

C: The fingerprint dirt was clearly left.

Wiping-Out Property with Tissue

A fingerprint was repeatedly deposited with an index finger onto a surface of the lipophilic resin layer for 20 times. The deposited fingerprints were wiped-out with a tissue (ELLEAIR, manufactured by DAIO PAPER CORPORATION) by circularly moving it for 10 times, and then visually observed while illuminating the surface with a fluorescent light to thereby evaluate according to the following criteria.

### Evaluation Criteria

A: No fingerprint dirt was lest.

B: The fingerprint dirt was slightly left.

C: The fingerprint dirt was clearly left.

### Durability of Fingerprint Resistance

SAVINA MX (manufactured by KB SEIREN, LTD.) was impregnated with NIVEA FOR MEN UV PROTECTOR SPF50+ PA+++ (manufactured by Nivea-Kao Co, Ltd.), followed by placing on a surface of the lipophilic resin layer. The resultant was subjected to reciprocating sliding for 1,000 times (sliding stroke: 3 cm, sliding frequency: 60 Hz) with a load of 75 gf/cm². The surface of the lipophilic resin layer was washed with KIMWIPE impregnated with ethanol, followed by measuring for the oleic acid contact angle and evaluating according to the following criteria.

Note that, the reciprocating sliding simulates repeatedly fingerprint wiping motion.

### Evaluation Criteria

A: The fingerprint resistance was not changed.

B: The fingerprint resistance was slightly deteriorated.

C: The fingerprint resistance was clearly deteriorated.

### Molding

In-mold molding was carried out by the method shown in FIG. 12A to 12F, and the oleic acid contact angle, the deterioration of the fingerprint resistance relative to that of before molding, the Martens hardness, and the pencil hardness of the lipophilic resin layer after molding were evaluated by the above-described evaluation methods. Moreover, the appearance of the molded product was observed, and whether a scratch, a crack, or peeling was present or not was evaluated.

Note that, the heating (infrared heating) temperature in the heating step of heating the lipophilic laminate was set to 190° C., and a polycarbonate was used as a molding material. In the in-mold molding, the elongation percentage at the most elongated part of the lipophilic laminate was 40%. The oleic acid contact angle and the deterioration of the fingerprint resistance were evaluated at the part where the lipophilic laminate was elongated by 10%.

### Example 2

A lipophilic laminate was prepared in the same manner as in Example 1 except that the exposure pattern of the resist layer in preparing the glass roll matrix in Example 1 was changed.

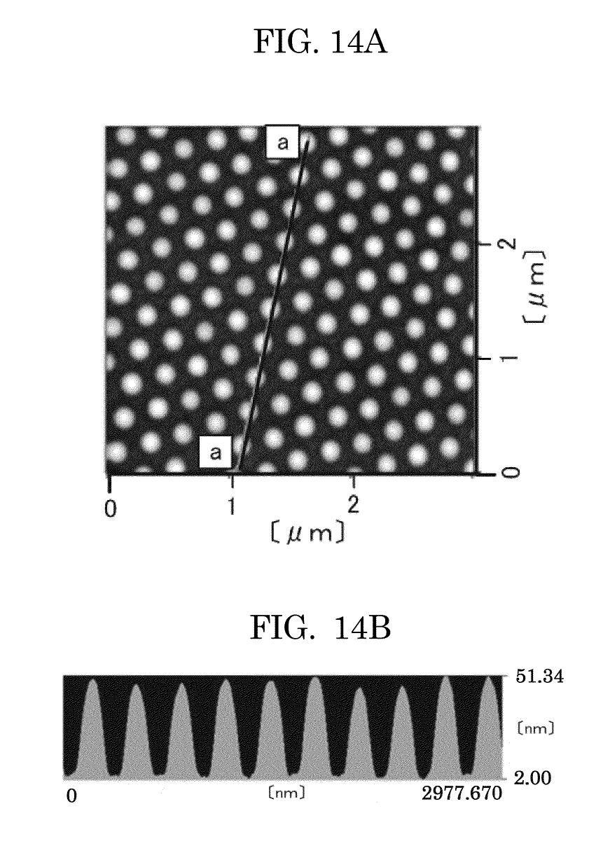

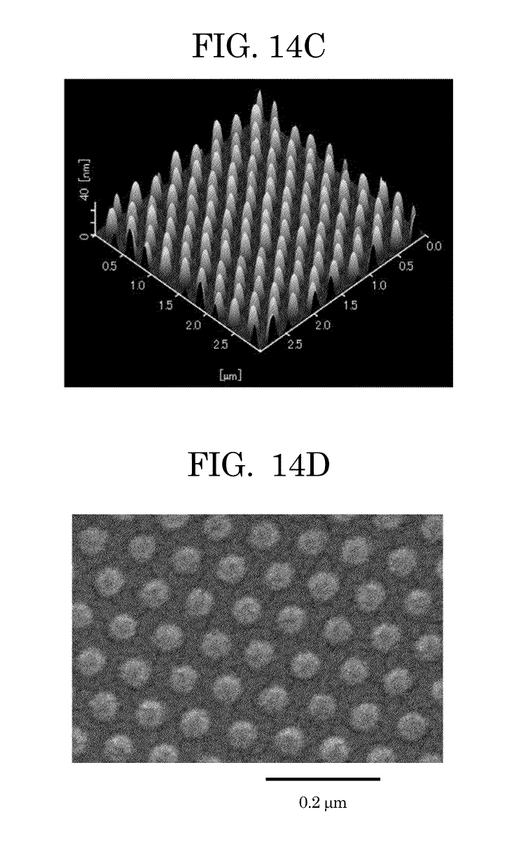

An AFM image of a surface of the lipophilic resin layer of the obtained lipophilic laminate is shown in FIG. 14A. A cross sectional view along the a-a line in FIG. 14A is shown in FIG. 14B. A three-dimensional AFM image of the lipophilic resin layer is shown in FIG. 14C. A SEM image of the lipophilic resin layer is shown in FIG. 14D.

The same evaluation as in Example 1 with regard to the prepared lipophilic laminate was carried out. The results are shown in Tables 2 and 3.

### Example 3

A lipophilic laminate was prepared in the same manner as in Example 1 except that the exposure pattern of the resist layer in preparing the glass roll matrix in Example 1 was reversed.

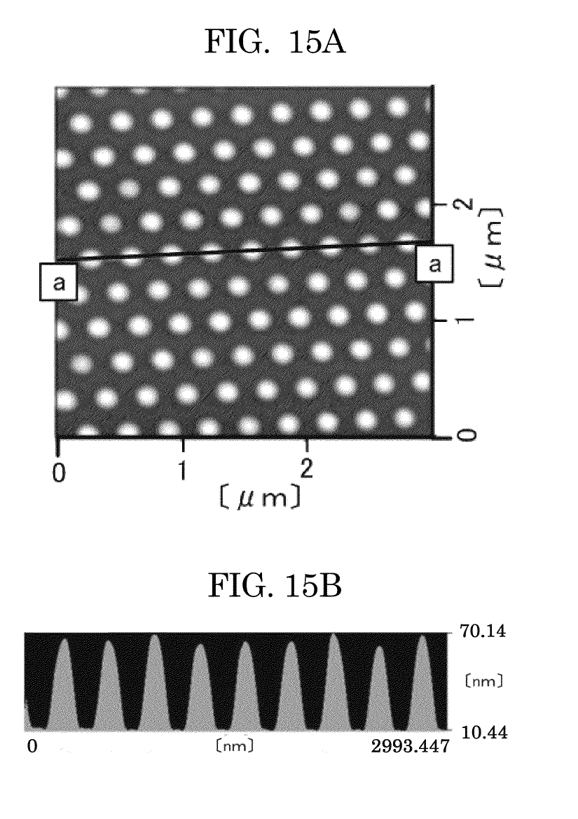

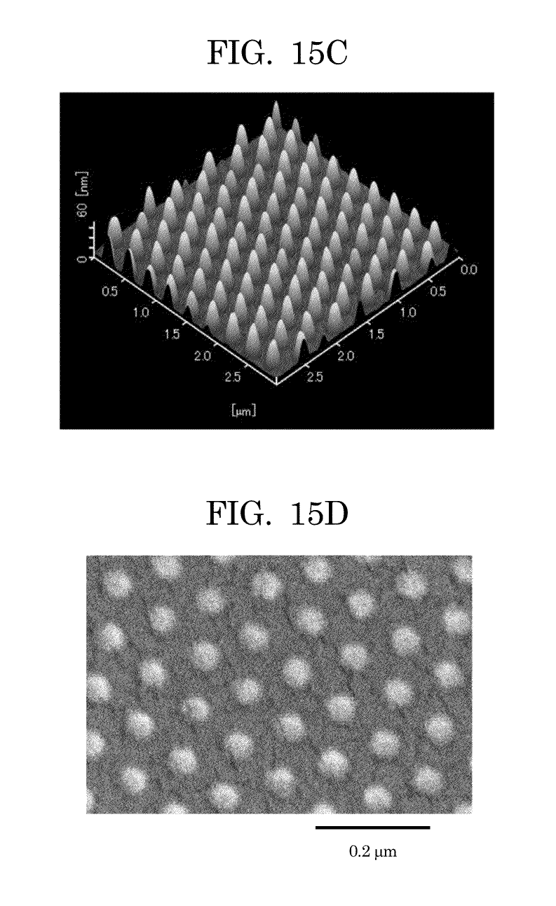

An AFM image of a surface of the lipophilic resin layer of the obtained lipophilic laminate is shown in FIG. 15A. A cross sectional view along the a-a line in FIG. 15A is shown in FIG. 15B. A three-dimensional AFM image of the lipophilic resin layer is shown in FIG. 15C. A SEM image of the lipophilic resin layer is shown in FIG. 15D.

The same evaluation as in Example 1 with regard to the prepared lipophilic laminate was carried out. The results are shown in Tables 2 and 3.

### Example 4

A lipophilic laminate was prepared in the same manner as in Example 1 except that the exposure pattern of the resist layer in preparing the glass roll matrix in Example 1 was changed.

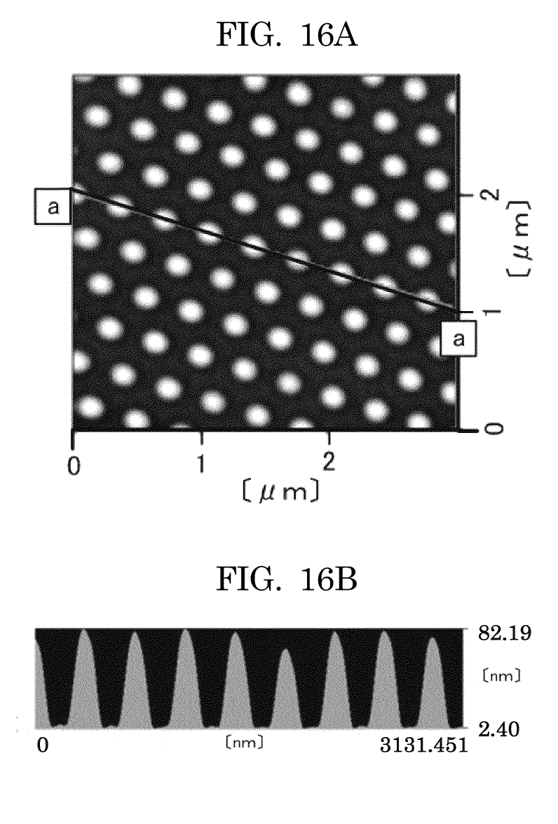

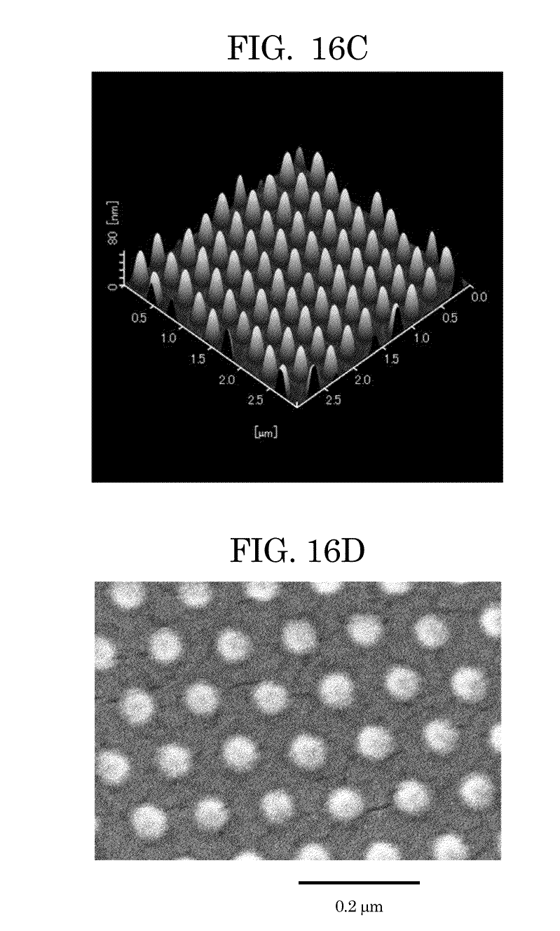

An AFM image of a surface of the lipophilic resin layer of the obtained lipophilic laminate is shown in FIG. 16A. A cross sectional view along the a-a line in FIG. 16A is shown in FIG. 16B. A three-dimensional AFM image of the lipophilic resin layer is shown in FIG. 16C. A SEM image of the lipophilic resin layer is shown in FIG. 16D.

The same evaluation as in Example 1 with regard to the prepared lipophilic laminate was carried out. The results are shown in Tables 2 and 3.

### Example 5

A lipophilic laminate was prepared in the same manner as in Example 2 except that the etching time in preparing the glass roll matrix in Example 2 was changed.

### Ultraviolet Curable Resin Composition for Lipophilic Resin Layer

| | | |
|---|---|---|
| 8UX-015A (pentadecafunctional urethane | 79.2 | parts by mass |
| acrylate, manufactured by Taisei Fine Chemical | | |
| Co., Ltd.) | | |
| CN968 (hexafunctional aliphatic urethane | 15.8 | parts by mass |
| acrylate, manufactured by Sartomer Company, | | |
| Inc.) | | |
| LUCIRIN TPO (manufactured by BASF) | 5 | parts by mass |

The same evaluation as in Example 1 with regard to the prepared lipophilic laminate was carried out. The results are shown in Tables 2 and 3.

### Example 6

A lipophilic laminate was prepared in the same manner as in Example 2 except that the substrate made of a resin in Example 2 was changed to a substrate made of a resin (SOFT SHINE TA009, manufactured by TOYOBO CO., LTD., average thickness: 125 μm, polyethylene terephthalate), and the anchor layer was not formed.

The same evaluation as in Example 1 with regard to the prepared lipophilic laminate was carried out. The results are shown in Tables 2 and 3.

### Example 7

### Preparation of Transfer Matrix Plate-Form Matrix) Having Micro Convex Portions or Micro Concave Portions

An apparatus shown in FIG. 8 was used as a laser processing apparatus. IFRIT (trade name; manufactured by Cyber Laser Inc.) was used as a laser main-body 340. The wavelength of the laser was set to 800 nm, the repetition frequency was set to 1,000 Hz, and the pulse width was set to 220 fs.

Firstly, a matrix was prepared by coating a surface of a plate-form substrate (SUS) with DLC (Diamond-Like Carbon) by a spattering method. Next, micro concave portions were formed on the surface of the DLC film of the matrix using the laser processing apparatus. In forming the concave portions, laser processing was applied under the laser processing conditions shown in Table 1. A plate-form matrix for shape transfer was obtained in the manner as described above. Note that, the size of the matrix was made to be a rectangular shape of 2 cm×2 cm.

TABLE 1

| | | Laser processing conditions | | | | | | | |
|---|---|---|---|---|---|---|---|---|---|
| | Matrix | Wavelength | Polarization | P | Lx (μm) | Ly (μm) | v | | F |
| | material | (nm) | of light | (mW) | Width | Length | (mm/s) | N | (J/cm²) |
| Example 7 | DLC | 800 | Linear | 96 | 300 | 160 | 8 | 20 | 0.2 |
| Example 8 | DLC | 800 | Linear | 96 | 300 | 160 | 5.33 | 30 | 0.2 |
| Example 9 | DLC | 800 | Circular | 96 | 300 | 160 | 8 | 20 | 0.2 |
| Example 10 | DLC | 800 | Circular | 96 | 300 | 160 | 5.33 | 30 | 0.2 |

### Preparation of Lipophilic Laminate

Next, a lipophilic laminate was prepared by UV imprint using the plate-form matrix obtained in the manner described above. Specifically, the preparation was carried out in the following manner.

A lipophilic laminate was prepared in the same manner as in Example 1 except that the roll matrix was changed to the plate-form matrix obtained in the manner described above in the preparation of the lipophilic laminate of Example 1.

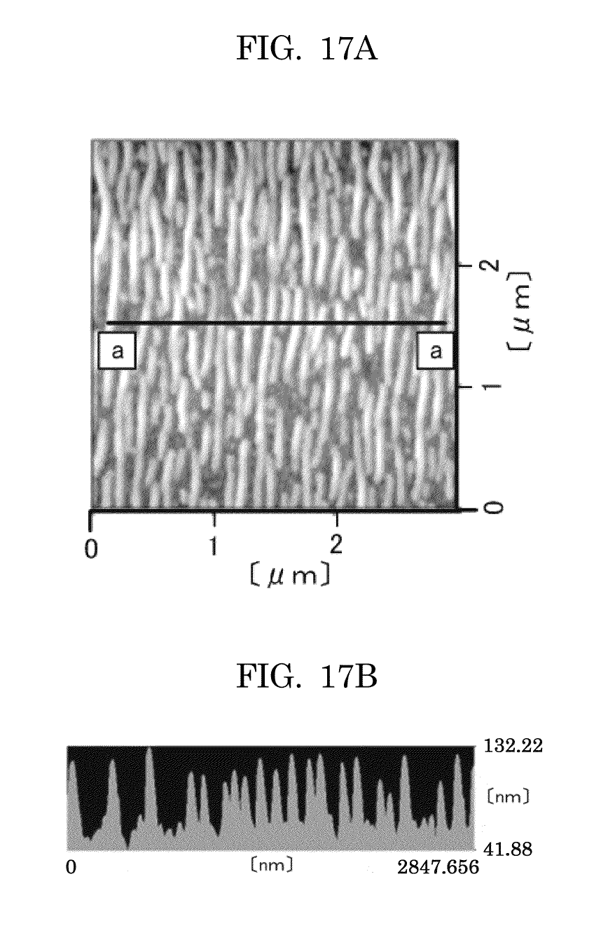

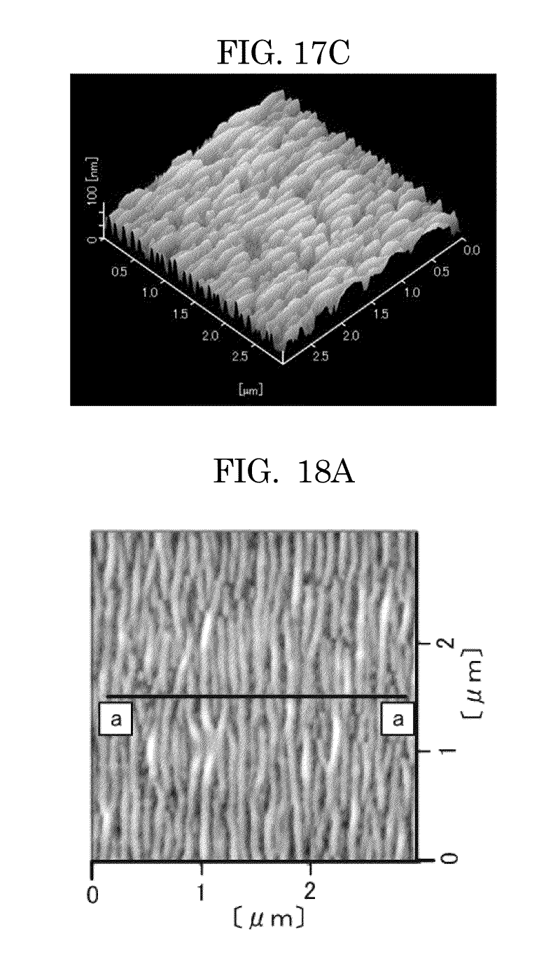

An AFM image of a surface of the lipophilic resin layer of the obtained lipophilic laminate is shown in FIG. 17A. A cross sectional view along the a-a line in FIG. 17A is shown in FIG. 17B. A three-dimensional AFM image of the lipophilic resin layer is shown in FIG. 17C.

The same evaluation as in Example 1 with regard to the prepared lipophilic laminate was carried out. The results are shown in Tables 2 and 3.

### Examples 8 to 10

Lipophilic laminates were prepared in the same manner as in Example 7 except that the conditions in preparing the plate-form matrix in Example 7 were changed to the conditions shown in Table 1.

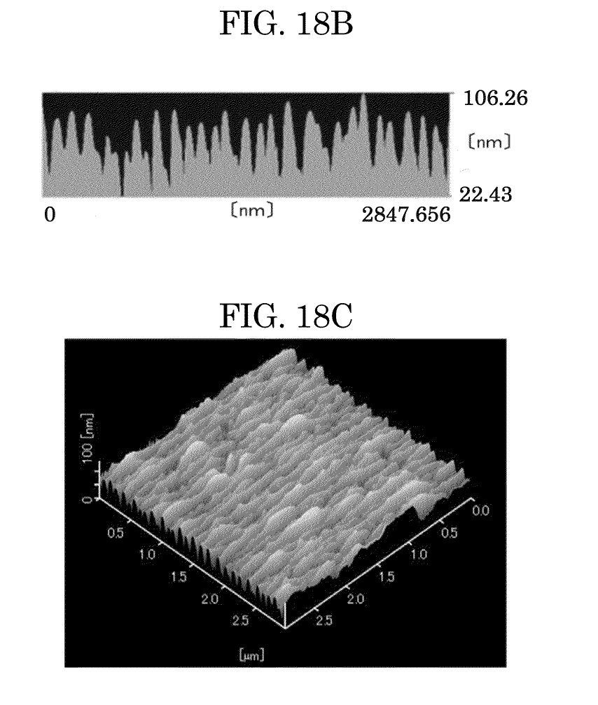

An AFM image of a surface of the lipophilic resin layer of the obtained lipophilic laminate of Example 8 is shown in FIG. 18A. A cross sectional view along the a-a line in FIG. 18A is shown in FIG. 18B. A three-dimensional AFM image of the lipophilic resin layer is shown in FIG. 18C.

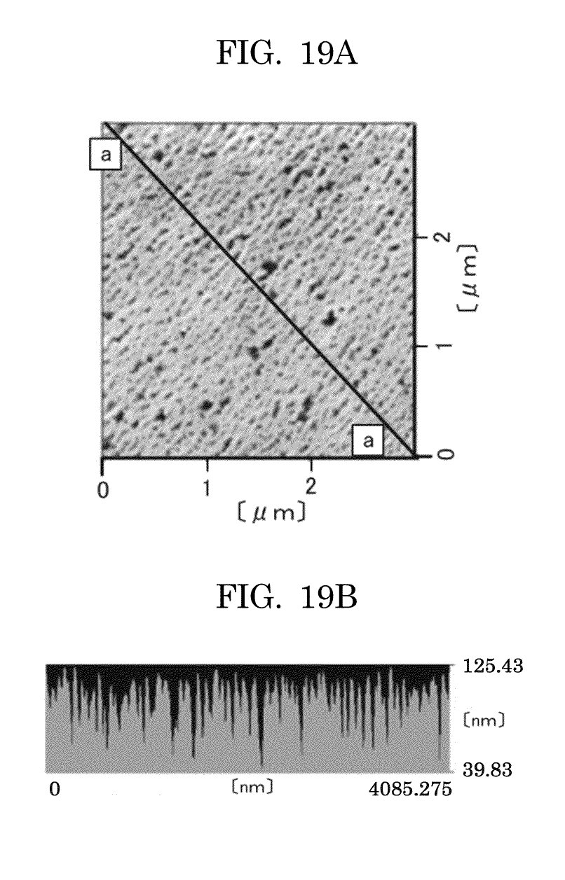

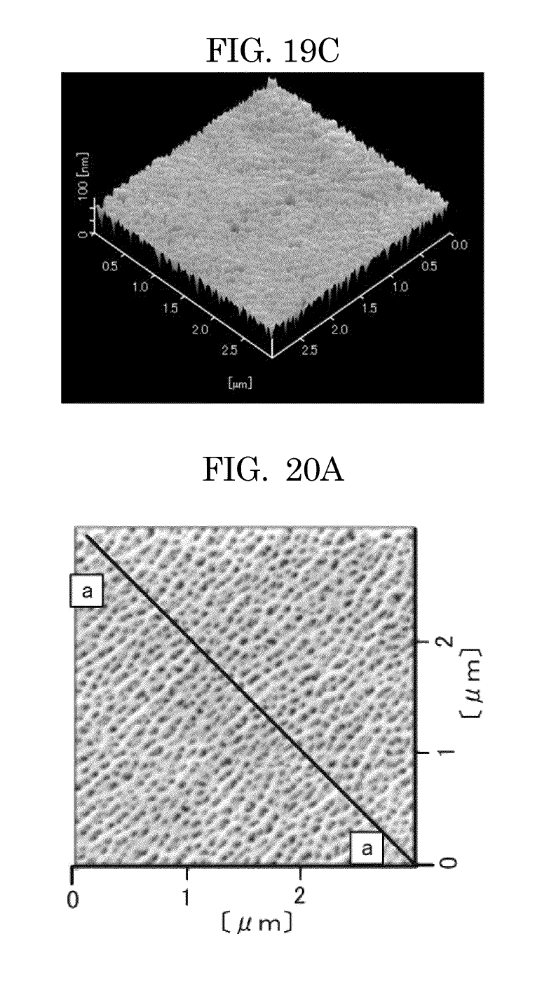

An AFM image of a surface of the lipophilic resin layer of the obtained lipophilic laminate of Example 9 is shown in FIG. 19A. A cross sectional view along the a-a line in FIG. 19A is shown in FIG. 19B. A three-dimensional AFM image of the lipophilic resin layer is shown in FIG. 19C.

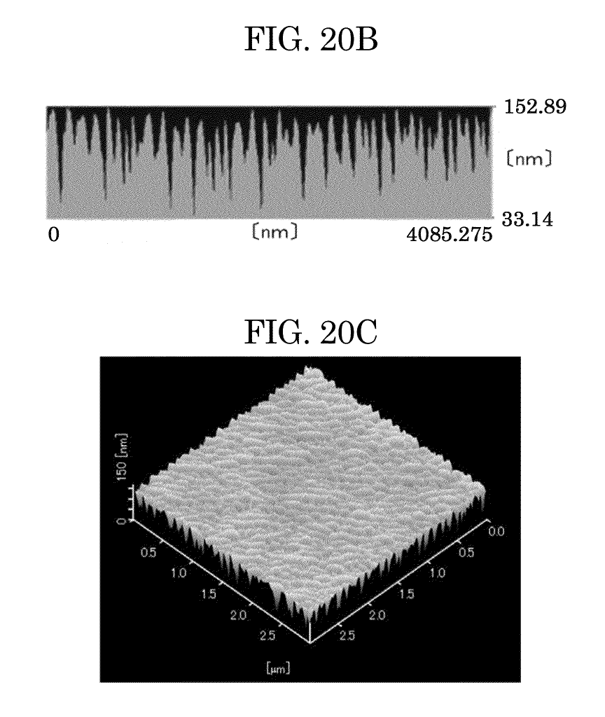

An AFM image of a surface of the lipophilic resin layer of the obtained lipophilic laminate of Example 10 is shown in FIG. 20A. A cross sectional view along the a-a line in FIG. 20A is shown in FIG. 20B. A three-dimensional AFM image of the lipophilic resin layer is shown in FIG. 20C.

The same evaluation as in Example 1 with regard to the prepared lipophilic laminates was carried out. The results are shown in Tables 2 and 3.

### Example 11

A hydrophilic laminate was prepared in the same manner as in Example 2 except that the ultraviolet curable resin composition for a lipophilic resin layer in Example 2 was changed to the following ultraviolet curable resin composition for a lipophilic resin layer, which was applied onto an anchor layer of a substrate made of a resin and having the anchor layer so that the average thickness of the hydrophilic resin layer to be obtained became 7.0 μm.

The same evaluation as in Example 1 with regard to the prepared lipophilic laminate was carried out. The results are shown in Tables 2 and 3.

### Ultraviolet Curable Resin Composition for Lipophilic Resin Layer

| | |
|---|---|
| EPOXYESTER 80MFA (difunctional epoxyacrylate, | 95 parts by mass |
| manufactured by kyoeisha Chemical Co., Ltd.) | |
| LUCIRIN TPO (manufactured by BASF) | 5 parts by mass |

### Example 12

A hydrophilic laminate was prepared in the same manner as in Example 2 except that the ultraviolet curable resin composition for a lipophilic resin layer in Example 2 was changed to the following ultraviolet curable resin composition for a lipophilic resin layer, which was applied onto an anchor layer of a substrate made of a resin and having the anchor layer so that the average thickness of the hydrophilic resin layer to be obtained became 1.6 μm.

The same evaluation as in Example 1 with regard to the prepared lipophilic laminate was carried out. The results are shown in Tables 2 and 3.

### Ultraviolet Curable Resin Composition for Lipophilic Resin Layer

| | |
|---|---|
| A-9300 (ethoxylated isocyanuric acid triacrylate, | 32 parts by mass |
| manufactured by Shin Nakamura Chemical Co., Ltd.) | |
| CN985B88 (aliphatic urethane acrylate, manufactured | 32 parts by mass |
| by Sartomer Company, Inc.) | |
| MPEM-1000 (methoxy polyethylene glycol 1000 | 32 parts by mass |
| methacrylate, manufacture by Dai-ichi Kogyo | |
| Seiyaku Co., Ltd.) | |
| LUCIRIN TPO (manufactured by BASF) | 4 parts by mass |

### Example 13

A hydrophilic laminate was prepared in the same manner as in Example 2 except that the ultraviolet curable resin composition for a lipophilic resin layer in Example 2 was changed to the following ultraviolet curable resin composition for a lipophilic resin layer.

The same evaluation as in Example 1 with regard to the prepared lipophilic laminate was carried out. The results are shown in Tables 2 and 3.

### Ultraviolet Curable Resin Composition for Lipophilic Resin Layer

| | |
|---|---|
| CN985B88 (aliphatic urethane acrylate, manufactured | 77 parts by mass |
| by Sartomer Company, Inc.) | |
| A-9300 (ethoxylated isocyanuric acid triacrylate, | 18 parts by mass |
| manufactured by Shin Nakamura Chemical Co., Ltd.) | |
| LUCIRIN TPO (manufactured by BASF) | 5 parts by mass |

### Example 14

A hydrophilic laminate was prepared in the same manner as in Example 2 except that the ultraviolet curable resin composition for a lipophilic resin layer in Example 2 was changed to the following ultraviolet curable resin composition for a lipophilic resin layer.

The same evaluation as in Example 1 with regard to the prepared lipophilic laminate was carried out. The results are shown in Tables 2 and 3.

### Ultraviolet Curable Resin Composition for Lipophilic Resin Layer

| | |
|---|---|
| CN985B88 (aliphatic urethane acrylate, manufactured | 32 parts by mass |
| by Sartomer Company, Inc.) | |
| CN9008 (urethane acrylate oligomer, manufactured | 32 parts by mass |
| by Sartomer Company, Inc.) | |
| SR606A (esterdiol diacrylate, manufactured by | 31 parts by mass |
| Sartomer Company, Inc.) | |
| LUCIRIN TPO (manufactured by BASF) | 5 parts by mass |

### Example 15

A hydrophilic laminate was prepared in the same manner as in Example 2 except that the ultraviolet curable resin composition for a lipophilic resin layer in Example 2 was changed to the following ultraviolet curable resin composition for a lipophilic resin layer, which was applied onto an anchor layer of a substrate made of a resin and having the anchor layer so that the average thickness of the hydrophilic resin layer to be obtained became 4.0 μm.

The same evaluation as in Example 1 with regard to the prepared lipophilic laminate was carried out. The results are shown in Tables 2 and 3.

### Ultraviolet Curable Resin Composition for Lipophilic Resin Layer

| | |
|---|---|
| CN9008 (urethane acrylate oligomer, manufactured | 64 parts by mass |
| by Sartomer Company, Inc.) | |
| SR606A (esterdiol diacrylate, manufactured by | 31 parts by mass |
| Sartomer Company, Inc.) | |
| LUCIRIN TPO (manufactured by BASF) | 5 parts by mass |

### Comparative Example 1

A laminate was obtained in the same manner as in Example 1 except that the roll matrix was not brought into contact with the substrate made of a resin and having an anchor layer to which substrate the ultraviolet curable resin composition for a hydrophilic resin layer was applied in Example 1.

The same evaluation as in Example 1 with regard to the prepared lipophilic laminate was carried out. The results are shown in Tables 2 and 3.

### Comparative Example 2

A laminate was obtained in the same manner as in Example 5 except that the roll matrix was not brought into contact with the substrate made of a resin and having an anchor layer to which substrate the ultraviolet curable resin composition for a hydrophilic resin layer was applied in Example 5.

The same evaluation as in Example 1 with regard to the prepared lipophilic laminate was carried out. The results are shown in Tables 2 and 3.

### Comparative Example 3

A hydrophilic laminate was prepared in the same manner as in Comparative Example 1 except that the ultraviolet curable resin composition for a lipophilic resin layer in Comparative Example 1 was changed to the following ultraviolet curable resin composition for a lipophilic resin layer, which was applied onto a substrate made of a resin and having an anchor layer, followed by drying a solvent with a drier.

The same evaluation as in Example 1 with regard to the prepared lipophilic laminate was carried out. The results are shown in Tables 2 and 3.

### Ultraviolet Curable Resin Composition for Lipophilic Resin Layer

| | | |
|---|---|---|
| CN985B88 (difunctional aliphatic urethane | 92.5 | parts by mass |
| acrylate, manufactured by Sartomer Company, | | |
| Inc.) | | |
| OD-002 (lipophilic surface modifying agent, | 2.5 | parts by mass |
| manufactured by Nissan Chemical Industries, | | |
| Ltd.) | | |
| LUCIRIN TPO (manufactured by BASF) | 5 | parts by mass |
| Methyl isobutyl ketone (solvent) | 100 | parts by mass |

### Comparative Example 4

A laminate was obtained in the same manner as in Example 11 except that the roll matrix was not brought into contact with the substrate made of a resin and having an anchor layer to which substrate the ultraviolet curable resin composition for a hydrophilic resin layer was applied in Example 11.

The same evaluation as in Example 1 with regard to the prepared lipophilic laminate was carried out. The results are shown in Tables 2 and 3.

### Comparative Example 5

A laminate was obtained in the same manner as in Example 12 except that the roll matrix was not brought into contact with the substrate made of a resin and having an anchor layer to which substrate the ultraviolet curable resin composition for a hydrophilic resin layer was applied in Example 12.

The same evaluation as in Example 1 with regard to the prepared lipophilic laminate was carried out. The results are shown in Tables 2 and 3.

### Comparative Example 6

A hydrophilic laminate was prepared in the same manner as in Example 11 except that the exposure pattern of the resist layer in preparing the glass roll matrix in Example 11 was changed.

The same evaluation as in Example 1 with regard to the prepared lipophilic laminate was carried out. The results are shown in Tables 2 and 3.

TABLE 2

| | | (Hydrophobic) Resin layer | | | | | | |
|---|---|---|---|---|---|---|---|---|
| | | | | | | Average | Oleic acid | Change of oleic |
| | Substrate | Pm | Hm | Hm/ | Dm | thickness | contact angle | acid contact |
| | made of resin | (nm) | (nm) | Pm | (nm) | (μm) | (°) | angle (°) |
| Ex. 1 | PMMA/PC | 250 | 60 | 0.24 | 105 | 3.2 | 2.5 | 3.2 |
| Ex. 2 | PMMA/PC | 270 | 60 | 0.22 | 140 | 3.2 | 1.5 | 2.6 |
| Ex. 3 | PMMA/PC | 310 | 60 | 0.19 | 170 | 3.2 | 1.0 | 2.5 |
| Ex. 4 | PMMA/PC | 350 | 80 | 0.23 | 180 | 3.2 | 1.0 | 2.2 |
| Ex. 5 | PMMA/PC | 270 | 60 | 0.22 | 140 | 3.2 | 1.7 | 3.3 |
| Ex. 6 | PET | 270 | 60 | 0.22 | 140 | 3.2 | 1.5 | 2.6 |
| Ex. 7 | PMMA/PC | 150 | 63 | 0.42 | 58 | 3.2 | 2.5 | 1.4 |
| Ex. 8 | PMMA/PC | 100 | 48 | 0.48 | 40 | 3.2 | 2.3 | 1.7 |
| Ex. 9 | PMMA/PC | 50 | 39 | 0.78 | 25 | 3.2 | 2.3 | 1.6 |
| Ex. 10 | PMMA/PC | 80 | 60 | 0.75 | 50 | 3.2 | 2.1 | 1.7 |
| Ex. 11 | PMMA/PC | 270 | 60 | 0.22 | 140 | 7.0 | 8.3 | 1.1 |
| Ex. 12 | PMMA/PC | 270 | 60 | 0.22 | 140 | 1.6 | 1.4 | 2.6 |
| Ex. 13 | PMMA/PC | 270 | 60 | 0.22 | 140 | 3.2 | 2.6 | 1.5 |
| Ex. 14 | PMMA/PC | 270 | 60 | 0.22 | 140 | 3.2 | 2.1 | 2.3 |
| Ex. 15 | PMMA/PC | 270 | 60 | 0.22 | 140 | 4.0 | 1.4 | 2.5 |
| Comp. Ex. 1 | PMMA/PC | Flat surface | | | | 3.2 | 6.5 | 1.2 |
| Comp. Ex. 2 | PMMA/PC | Flat surface | | | | 3.2 | 10 | 0.3 |
| Comp. Ex. 3 | PMMA/PC | Flat surface | | | | 3.2 | 4.0 | 4.0 |
| Comp. Ex. 4 | PMMA/PC | Flat surface | | | | 7.0 | 12 | 0 |
| Comp. Ex. 5 | PMMA/PC | Flat surface | | | | 1.6 | 4.1 | 3.8 |
| Comp. Ex. 6 | PMMA/PC | 270 | 9 | 0.03 | 200 | 7.0 | 11 | 0.5 |

| | Martens | | Elongation | Total light | | | Difference in |
|---|---|---|---|---|---|---|---|
| | hardness | Pencil | percentage | transmittance | Haze | | heat shrinkage |
| | (N/mm²) | hardness | (%) | (%) | (%) | Adhesion | rate (%) |
| Ex. 1 | 176 | H | 42 | 91.5 | 0.3 | 100/100 | 0.5 |
| Ex. 2 | 176 | H | 42 | 91.7 | 0.3 | 100/100 | 0.5 |
| Ex. 3 | 176 | H | 42 | 91.8 | 0.3 | 100/100 | 0.5 |
| Ex. 4 | 176 | H | 42 | 91.7 | 0.3 | 100/100 | 0.5 |
| Ex. 5 | 202 | 2H | 15 | 91.4 | 0.3 | 100/100 | 0.5 |
| Ex. 6 | 176 | H | 42 | 90.2 | 0.3 | 100/100 | 2.0 |
| Ex. 7 | 176 | H | 42 | 93.0 | 0.3 | 100/100 | 0.5 |
| Ex. 8 | 176 | H | 42 | 93.1 | 0.3 | 100/100 | 0.5 |
| Ex. 9 | 176 | H | 42 | 92.8 | 0.3 | 100/100 | 0.5 |
| Ex. 10 | 176 | H | 42 | 92.9 | 0.3 | 100/100 | 0.5 |
| Ex. 11 | 86 | F | 40 | 91.6 | 0.3 | 100/100 | 0.5 |
| Ex. 12 | 90 | F | 50 | 91.7 | 0.3 | 100/100 | 0.5 |
| Ex. 13 | 208 | 2H | 31 | 91.6 | 0.3 | 100/100 | 0.5 |
| Ex. 14 | 160 | H | 51 | 91.6 | 0.3 | 100/100 | 0.5 |
| Ex. 15 | 144 | H | 56 | 91.6 | 0.3 | 100/100 | 0.5 |
| Comp. Ex. 1 | 176 | H | 42 | 91.5 | 0.3 | 100/100 | 0.5 |
| Comp. Ex. 2 | 202 | 2H | 15 | 91.4 | 0.3 | 100/100 | 0.5 |
| Comp. Ex. 3 | 176 | H | 42 | 91.5 | 0.3 | 100/100 | 0.5 |
| Comp. Ex. 4 | 86 | F | 40 | 91.5 | 0.3 | 100/100 | 0.5 |
| Comp. Ex. 5 | 90 | F | 50 | 91.6 | 0.3 | 100/100 | 0.5 |
| Comp. Ex. 6 | 86 | F | 40 | 91.6 | 0.3 | 100/100 | 0.5 |

TABLE 3

| | Fingerprint resistance | | | Durability test | |
|---|---|---|---|---|---|
| | Inconspicuousness of | Wiping-out | Wiping-out | Oleic acid | Anti- |
| | deposited fingerprint | property with finger | property with tissue | contact angle (°) | fingerprint property |
| Ex. 1 | A | A | A | 2.7 | A |
| Ex. 2 | A | A | A | 1.8 | A |
| Ex. 3 | A | A | A | 1.0 | A |
| Ex. 4 | A | A | A | 1.3 | A |
| Ex. 5 | A | A | A | 1.7 | A |
| Ex. 6 | A | A | A | 1.7 | A |
| Ex. 7 | B | A | A | 2.5 | A |
| Ex. 8 | B | A | A | 2.5 | A |
| Ex. 9 | B | A | A | 2.5 | A |
| Ex. 10 | B | A | A | 2.5 | A |
| Ex. 11 | B | A | A | 9.0 | A |
| Ex. 12 | A | A | A | 3.0 | A |
| Ex. 13 | A | A | A | 2.6 | A |
| Ex. 14 | A | A | A | 2.6 | A |
| Ex. 15 | A | A | A | 2.6 | A |
| Comp. | B | C | C | 9.0 | A |
| Ex. 1 | | | | | |
| Comp. | C | C | C | 11 | A |
| Ex. 2 | | | | | |
| Comp. | B | B | B | 11 | C |
| Ex. 3 | | | | | |
| Comp. | C | C | C | 13 | A |
| Ex. 4 | | | | | |
| Comp. | B | B | B | 7.0 | B |
| Ex. 5 | | | | | |
| Comp. | C | C | C | 12 | A |
| Ex. 6 | | | | | |

| | After molding | | | | | | |
|---|---|---|---|---|---|---|---|
| | Oleic acid | Deterioration | Martens | | | | |
| | contact angle | of fingerprint | hardness | Pencil | Appearance of lipophilic resin layer | | |
| | (°) | resistance | (N/mm²) | hardness | Scratch | Crack | Peeling |
| Ex. 1 | 2.8 | No | 206 | 3H | No | No | No |
| Ex. 2 | 1.9 | No | 206 | 3H | No | No | No |
| Ex. 3 | 1.4 | No | 206 | 3H | No | No | No |
| Ex. 4 | 1.3 | No | 206 | 3H | No | No | No |
| Ex. 5 | 1.9 | No | 220 | 3H | No | Partially | No |
| | | | | | | occurred | |
| Ex. 6 | 1.5 | No | 206 | 3H | No | No | No |
| Ex. 7 | 2.9 | No | 206 | 3H | No | No | No |
| Ex. 8 | 2.5 | No | 206 | 3H | No | No | No |
| Ex. 9 | 2.5 | No | 206 | 3H | No | No | No |
| Ex. 10 | 2.3 | No | 206 | 3H | No | No | No |
| Ex. 11 | 8.8 | No | 100 | 2H | No | No | No |
| Ex. 12 | 2.0 | No | 109 | 2H | No | No | No |
| Ex. 13 | 2.9 | No | 225 | 3H | No | Partially | No |
| | | | | | | occurred | |
| Ex. 14 | 2.6 | No | 190 | 3H | No | No | No |
| Ex. 15 | 2.5 | No | 150 | 2H | No | No | No |
| Comp. | 8.0 | No | 206 | 3H | No | No | No |
| Ex. 1 | | | | | | | |
| Comp. | 10 | No | 220 | 3H | No | Partially | No |
| Ex. 2 | | | | | | occurred | |
| Comp. | 4.0 | No | 206 | 3H | No | No | No |
| Ex. 3 | | | | | | | |
| Comp. | 13 | No | 100 | 2H | No | No | No |
| Ex. 4 | | | | | | | |
| Comp. | 4.3 | No | 109 | 2H | No | No | No |
| Ex. 5 | | | | | | | |
| Comp. | 12 | No | 100 | 2H | No | No | No |
| Ex. 6 | | | | | | | |

The lipophilic laminates of Examples 1 to 15 were excellent in the fingerprint resistance (all of the inconspicuousness of deposited fingerprint, wiping-out property with finger, and wiping-out property), and even after the durability test, had a small oleic acid contact angle and were excellent in the fingerprint resistance. Additionally, even after molding, the lipophilic laminates had a small oleic acid contact angle, were not deteriorated in the fingerprint resistance, and were excellent in appearance (scratch, crack, and peeling). Examples 1 to 6 and 12 to 15 were more excellent in the inconspicuousness of deposited fingerprint.

In Examples 1 to 4, wide average distance and average space distance of micro convex portions allowed the oleic acid contact angle to be smaller, and oleic acid to more effectively spread in wet condition. In addition, the fingerprint resistance was improved, which is believed to resulted from that the volume of fine grooves in the lipophilic resin layer was increased and large capillary force was allowed to act with oleic acid and the fingerprint.

Note that, in Examples having the Martens hardness of more than 200 N/mm², an effect of improving the scratch resistance compared to a flat surface was confirmed due to the presence of micro convex portions or micro concave portions.

Meanwhile, the laminates of Comparative Examples 1, 2, 4, and 5 having neither micro convex portions nor micro concave portions had larger oleic acid contact angles than Examples 1 to 15, and had insufficiently fingerprint resistance even though they contain the resin composition having the same composition of the most superficial layer as each other. In addition, the fingerprint resistance after molding was also unsatisfactory.

As can be seen from the result of the laminate of Comparative Example 3, although it has a flat surface, the addition of the lipophilic surface modifying agent allowed the oleic acid contact angle to be smaller, and the fingerprint resistance to improve. However, after the durability test, an effect of the lipophilic surface modifying agent was eliminated, leading to deterioration of the fingerprint resistance.

As can be seen from the result of the laminate of Comparative Example 6, although it has micro concave portions on a surface thereof, in the case where the oleic acid contact angle was 11°, oleic acid did not effectively spread in wet condition and the fingerprint resistance was unsatisfactory. In addition, the change of the oleic acid contact angle was small, that is 0.5°.

### INDUSTRIAL APPLICABILITY

A lipophilic laminate of the present invention can be used by allowing it to adhere to touch panels, smartphones, covers for smartphones, tablet PCs, home electric appliances, cosmetic containers, and accessories. A lipophilic laminate of the present invention can be easily molded, so that it can be used for automobile interior part surfaces (e.g., door trims, instrument panels, center cluster/center console panels, shift knobs, members around a shift knob, and steering emblems) and automobile exterior part surfaces (e.g., door handles) utilizing in-mold forming, insert molding, or overlay molding.

### REFERENCE SIGNS LIST

211 Substrate made of resin
212 Lipophilic resin layer
231 Roll matrix
232 Structure
236 Uncured resin layer
237 Active energy ray
311 Substrate made of a resin
312 Lipophilic resin layer
331 Plate-form matrix
332 Structure
333 Uncured resin layer
334 Active energy ray

What is claimed is:

1. A lipophilic laminate, comprising:
a substrate made of a resin; and
a lipophilic resin layer on the substrate made of a resin,
wherein the lipophilic resin layer comprises micro convex portions or micro concave portions in a surface thereof, and
wherein an oleic acid contact angle of the surface of the lipophilic resin layer is 10° or less.

2. The lipophilic laminate according to claim 1, wherein the lipophilic laminate has an elongation percentage of 10% or more.

3. The lipophilic laminate according to claim 1, wherein a Martens hardness of the lipophilic resin layer is 50 N/mm² to 300 N/mm².

4. The lipophilic laminate according to claim 1, further comprising an anchor layer between the substrate made of a resin and the lipophilic resin layer.

5. The lipophilic laminate according to claim 1, wherein the oleic acid contact angle of the surface of the lipophilic resin layer gets smaller over time when the oleic acid contact angle is measured.

6. The lipophilic laminate according to claim 1, wherein the micro convex portions or the micro concave portions are spaced from each other.

7. A method for manufacturing a lipophilic laminate, comprising:
forming an uncured resin layer by applying an active energy ray curable resin composition to a substrate made of a resin; and
forming a lipophilic resin layer by bringing a transfer matrix having micro convex portions or micro concave portions into contact with the uncured resin layer, irradiating the uncured resin layer in contact with the transfer matrix with an active energy ray to cure the uncured resin layer, thereby transferring the micro convex portions or the micro concave portions,
wherein the lipophilic laminate comprises the substrate made of a resin, and the lipophilic resin layer on the substrate made of a resin,
wherein the lipophilic resin layer comprises the micro convex portions or the micro concave portions in a surface thereof, and
wherein an oleic acid contact angle of the surface of the lipophilic resin layer is 10° or less.

8. The method for manufacturing the lipophilic laminate according to claim 7, wherein the micro convex portions or the micro concave portions of the transfer matrix are formed by etching a surface of the transfer matrix with a photoresist having a predetermined pattern shape used as a protection film.

9. The method for manufacturing the lipophilic laminate according to claim 7, wherein the micro convex portions or the micro concave portions of the transfer matrix are formed by laser processing of the transfer matrix by irradiating the surface of the transfer matrix with a laser beam.

10. A product, comprising:
a lipophilic laminate on a surface thereof,
wherein the lipophilic laminate comprises a substrate made of a resin, and a lipophilic resin layer on the substrate made of a resin,
wherein the lipophilic resin layer comprises micro convex portions or micro concave portions in a surface thereof, and
wherein an oleic acid contact angle of the surface of the lipophilic resin layer is 10° or less.

11. A method for manufacturing a product, comprising:
heating a lipophilic laminate;
molding the lipophilic laminate heated into a desired shape; and
injecting a molding material to the lipophilic laminate molded in the desired shape at a side of a substrate made of a resin and molding the molding material,
wherein the product comprises the lipophilic laminate on a surface thereof,
wherein the lipophilic laminate comprises the substrate made of a resin, and the lipophilic resin layer on the substrate made of a resin,
wherein the lipophilic resin layer comprises micro convex portions or micro concave portions in a surface thereof, and
wherein an oleic acid contact angle of the surface of the lipophilic resin layer is 10° or less.

12. The method for manufacturing the product according to claim 11, wherein the heating is performed by infrared heating.
